(19) United States
(12) Patent Application Publication
(10) Pub. No.: US 2025/0106663 A1
(43) Pub. Date: Mar. 27, 2025

(54) REPORTING CHANNEL STATE INFORMATION MEASUREMENTS

(71) Applicant: QUALCOMM Incorporated, San Diego, CA (US)

(72) Inventors: Qiaoyu LI, Beijing (CN); Mahmoud TAHERZADEH BOROUJENI, San Diego, CA (US); Arumugam CHENDAMARAI KANNAN, San Diego, CA (US); Himanshu JOSHI, San Jose, CA (US); Taesang YOO, San Diego, CA (US); Tao LUO, San Diego, CA (US)

(21) Appl. No.: 18/727,237

(22) PCT Filed: Mar. 29, 2022
(86) PCT No.: PCT/CN2022/083589

§ 371 Date: Jul. 8, 2024

(51) Int. Cl. H04W 24/10; H04L 5/00

(52) U.S. Cl. CPC H04W 24/10; H04L 5/0048

(57) ABSTRACT

Various aspects of the present disclosure generally relate to wireless communication. In some aspects, a network node may receive a configuration corresponding to one or more channel state information (CSI) report settings associated with a reference signal resource set. The network node may transmit at least one CSI report that indicates a primary set of CSI measurements, of a plurality of CSI measurements associated with the reference signal resource set, and a secondary set of CSI measurements of the plurality of CSI measurements, wherein the plurality of CSI measurements comprises at least one of a physical layer reference signal received power (RSRP) value or a physical layer signal-to-interference-plus-noise ratio (SINR), and wherein the primary set of CSI measurements comprises at least one of a strongest RSRP value or a strongest SINR associated with the plurality of CSI measurements. Numerous other aspects are described.

### FIELD OF THE DISCLOSURE

Aspects of the present disclosure generally relate to wireless communication and to techniques and apparatuses for reporting channel state information measurements.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more base stations that support communication for a user equipment (UE) or multiple UEs. A UE may communicate with a base station via downlink communications and uplink communications. “Downlink” (or “DL”) refers to a communication link from the base station to the UE, and “uplink” (or “UL”) refers to a communication link from the UE to the base station.

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

Some aspects described herein relate to a network node for wireless communication. The network node may include a memory and one or more processors coupled to the memory. The one or more processors may be configured to receive a configuration corresponding to one or more channel state information (CSI) report settings associated with a reference signal resource set. The one or more processors may be configured to transmit, based at least in part on the configuration, at least one CSI report that indicates a primary set of CSI measurements, of a plurality of CSI measurements associated with the reference signal resource set, and a secondary set of CSI measurements of the plurality of CSI measurements, wherein the plurality of CSI measurements comprises at least one of a physical layer reference signal received power (RSRP) value or a physical layer signal-to-interference-plus-noise ratio (SINR), and wherein the primary set of CSI measurements comprises at least one of a strongest RSRP value or a strongest SINR associated with the plurality of CSI measurements and the secondary set of CSI measurements comprises one or more CSI measurements that are not included in the primary set of CSI measurements.

Some aspects described herein relate to a network node for wireless communication. The network node may include a memory and one or more processors coupled to the memory. The one or more processors may be configured to transmit a configuration corresponding to one or more CSI report settings associated with a reference signal resource set. The one or more processors may be configured to receive, based at least in part on the configuration, at least one CSI report that indicates a primary set of CSI measurements, of a plurality of CSI measurements associated with the reference signal resource set, and a secondary set of CSI measurements of the plurality of CSI measurements, wherein the plurality of CSI measurements comprises at least one of a physical layer RSRP value or a physical layer SINR, and wherein the primary set of CSI measurements comprises at least one of a strongest RSRP value or a strongest SINR associated with the plurality of CSI measurements and the secondary set of CSI measurements comprises one or more CSI measurements that are not included in the primary set of CSI measurements.

Some aspects described herein relate to a method of wireless communication performed by a network node. The method may include receiving a configuration corresponding to one or more CSI report settings associated with a reference signal resource set. The method may include transmitting, based at least in part on the configuration, at least one CSI report that indicates a primary set of CSI measurements, of a plurality of CSI measurements associated with the reference signal resource set, and a secondary set of CSI measurements of the plurality of CSI measurements, wherein the plurality of CSI measurements comprises at least one of a physical layer RSRP value or a physical layer SINR, and wherein the primary set of CSI measurements comprises at least one of a strongest RSRP value or a strongest SINR associated with the plurality of CSI measurements and the secondary set of CSI measurements comprises one or more CSI measurements that are not included in the primary set of CSI measurements.

Some aspects described herein relate to a method of wireless communication performed by a network node. The method may include transmitting a configuration corresponding to one or more CSI report settings associated with a reference signal resource set. The method may include receiving, based at least in part on the configuration, at least one CSI report that indicates a primary set of CSI measurements, of a plurality of CSI measurements associated with the reference signal resource set, and a secondary set of CSI measurements of the plurality of CSI measurements, wherein the plurality of CSI measurements comprises at least one of a physical layer RSRP value or a physical layer SINR, and wherein the primary set of CSI measurements comprises at least one of a strongest RSRP value or a strongest SINR associated with the plurality of CSI measurements and the secondary set of CSI measurements comprises one or more CSI measurements that are not included in the primary set of CSI measurements.

Some aspects described herein relate to a non-transitory computer-readable medium that stores a set of instructions for wireless communication by a network node. The set of instructions, when executed by one or more processors of the network node, may cause the network node to receive a configuration corresponding to one or more CSI report settings associated with a reference signal resource set. The set of instructions, when executed by one or more processors of the network node, may cause the network node to transmit, based at least in part on the configuration, at least one CSI report that indicates a primary set of CSI measurements, of a plurality of CSI measurements associated with the reference signal resource set, and a secondary set of CSI measurements of the plurality of CSI measurements, wherein the plurality of CSI measurements comprises at least one of a physical layer RSRP value or a physical layer SINR, and wherein the primary set of CSI measurements comprises at least one of a strongest RSRP value or a strongest SINR associated with the plurality of CSI measurements and the secondary set of CSI measurements comprises one or more CSI measurements that are not included in the primary set of CSI measurements.

Some aspects described herein relate to a non-transitory computer-readable medium that stores a set of instructions for wireless communication by a network node. The set of instructions, when executed by one or more processors of the network node, may cause the network node to transmit a configuration corresponding to one or more CSI report settings associated with a reference signal resource set. The set of instructions, when executed by one or more processors of the network node, may cause the network node to receive, based at least in part on the configuration, at least one CSI report that indicates a primary set of CSI measurements, of a plurality of CSI measurements associated with the reference signal resource set, and a secondary set of CSI measurements of the plurality of CSI measurements, wherein the plurality of CSI measurements comprises at least one of a physical layer RSRP value or a physical layer SINR, and wherein the primary set of CSI measurements comprises at least one of a strongest RSRP value or a strongest SINR associated with the plurality of CSI measurements and the secondary set of CSI measurements comprises one or more CSI measurements that are not included in the primary set of CSI measurements.

Some aspects described herein relate to an apparatus for wireless communication. The apparatus may include means for receiving a configuration corresponding to one or more CSI report settings associated with a reference signal resource set. The apparatus may include means for transmitting, based at least in part on the configuration, at least one CSI report that indicates a primary set of CSI measurements, of a plurality of CSI measurements associated with the reference signal resource set, and a secondary set of CSI measurements of the plurality of CSI measurements, wherein the plurality of CSI measurements comprises at least one of a physical layer RSRP value or a physical layer SINR, and wherein the primary set of CSI measurements comprises at least one of a strongest RSRP value or a strongest SINR associated with the plurality of CSI measurements and the secondary set of CSI measurements comprises one or more CSI measurements that are not included in the primary set of CSI measurements.

Some aspects described herein relate to an apparatus for wireless communication. The apparatus may include means for transmitting a configuration corresponding to one or more CSI report settings associated with a reference signal resource set. The apparatus may include means for receiving, based at least in part on the configuration, at least one CSI report that indicates a primary set of CSI measurements, of a plurality of CSI measurements associated with the reference signal resource set, and a secondary set of CSI measurements of the plurality of CSI measurements, wherein the plurality of CSI measurements comprises at least one of a physical layer RSRP value or a physical layer SINR, and wherein the primary set of CSI measurements comprises at least one of a strongest RSRP value or a strongest SINR associated with the plurality of CSI measurements and the secondary set of CSI measurements comprises one or more CSI measurements that are not included in the primary set of CSI measurements.

Aspects generally include a method, apparatus, system, computer program product, non-transitory computer-readable medium, user equipment, base station, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a base station in communication with a user equipment (UE) in a wireless network, in accordance with the present disclosure.

FIG. 3 is an example of an open radio access network architecture, in accordance with the present disclosure

FIG. 4 is a diagram illustrating an example of wireless communications, in accordance with the present disclosure.

FIG. 5 is a diagram illustrating an example associated with reporting channel state information (CSI) measurements, in accordance with the present disclosure.

FIGS. 6 and 7 are diagrams illustrating example processes associated with reporting CSI measurements, in accordance with the present disclosure.

FIG. 8 is a diagram of an example apparatus for wireless communication, in accordance with the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Aspects and examples generally include a method, apparatus, network node, system, computer program product, non-transitory computer-readable medium, user equipment, base station, wireless communication device, and/or processing system as described or substantially described herein with reference to and as illustrated by the drawings and specification.

This disclosure may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, are better understood from the following description when considered in connection with the accompanying figures. Each of the figures is provided for the purposes of illustration and description, and not as a definition of the limits of the claims.

While aspects are described in the present disclosure by illustration to some examples, such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component-based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). Aspects described herein may be practiced in a wide variety of devices, components, systems, distributed arrangements, and/or end-user devices of varying size, shape, and constitution.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

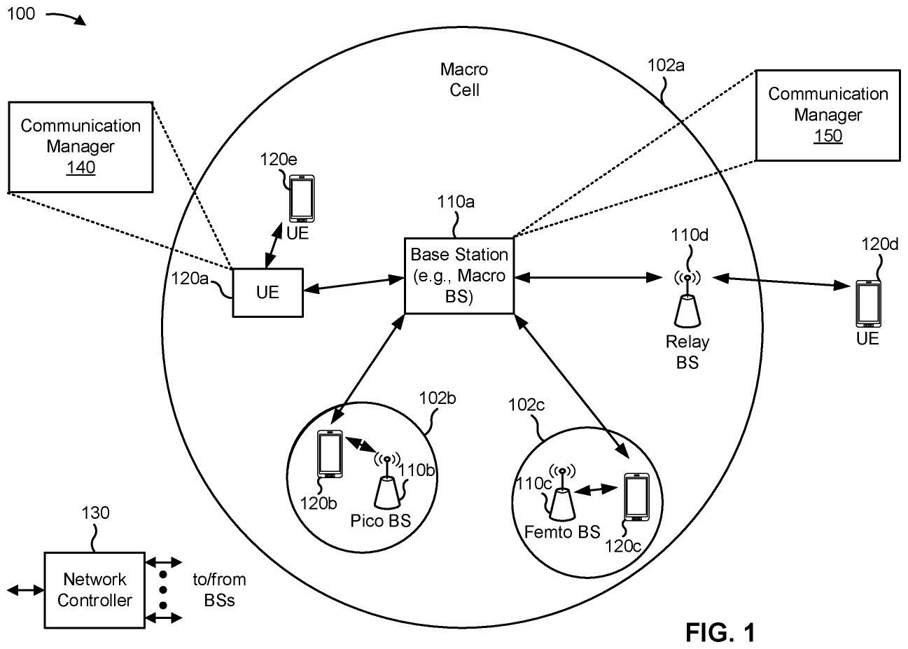

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include one or more base stations 110 (shown as a BS 110a, a BS 110b, a BS 110c, and a BS 110d), a user equipment (UE) 120 or multiple UEs 120 (shown as a UE 120a, a ULE 120b, a UE 120c, a UE 120d, and a UE 120e), and/or other network entities. A base station 110 is an entity that communicates with UEs 120. A base station 110 (sometimes referred to as a BS) may include, for example, an NR base station, an LTE base station, a Node B, an eNB (e.g., in 4G), a gNB (e.g., in 5G), an access point, and/or a transmission reception point (TRP). Each base station 110 may provide communication coverage for a particular geographic area. In the Third Generation Partnership Project (3GPP), the term “cell” can refer to a coverage area of a base station 110 and/or a base station subsystem serving this coverage area, depending on the context in which the term is used.

A base station 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscription. A femto cell may cover a relatively small geographic area (e.g., a home) and may allow restricted access by UEs 120 having association with the femto cell (e.g., UEs 120 in a closed subscriber group (CSG)). A base station 110 for a macro cell may be referred to as a macro base station. A base station 110 for a pico cell may be referred to as a pico base station. A base station 110 for a femto cell may be referred to as a femto base station or an in-home base station. In the example shown in FIG. 1, the BS 110a may be a macro base station for a macro cell 102a, the BS 110b may be a pico base station for a pico cell 102b, and the BS 110c may be a femto base station for a femto cell 102c. A base station may support one or multiple (e.g., three) cells.

In some examples, a cell may not necessarily be stationary, and the geographic area of the cell may move according to the location of a base station 110 that is mobile (e.g., a mobile base station). In some examples, the base stations 110 may be interconnected to one another and/or to one or more other base stations 110 or network nodes (not shown) in the wireless network 100 through various types of backhaul interfaces, such as a direct physical connection or a virtual network, using any suitable transport network.

The wireless network 100 may include one or more relay stations. A relay station is an entity that can receive a transmission of data from an upstream station (e.g., a base station 110 or a UE 120) and send a transmission of the data to a downstream station (e.g., a UE 120 or a base station 110). A relay station may be a UE 120 that can relay transmissions for other UEs 120. In the example shown in FIG. 1, the BS 110d (e.g., a relay base station) may communicate with the BS 110a (e.g., a macro base station) and the UE 120d in order to facilitate communication between the BS 110a and the UE 120d. A base station 110 that relays communications may be referred to as a relay station, a relay base station, a relay, or the like.

The wireless network 100 may be a heterogeneous network that includes base stations 110 of different types, such as macro base stations, pico base stations, femto base stations, relay base stations, or the like. These different types of base stations 110 may have different transmit power levels, different coverage areas, and/or different impacts on interference in the wireless network 100. For example, macro base stations may have a high transmit power level (e.g., 5 to 40 watts) whereas pico base stations, femto base stations, and relay base stations may have lower transmit power levels (e.g., 0.1 to 2 watts).

A network controller 130 may couple to or communicate with a set of base stations 110 and may provide coordination and control for these base stations 110. The network controller 130 may communicate with the base stations 110 via a backhaul communication link. The base stations 110 may communicate with one another directly or indirectly via a wireless or wireline backhaul communication link.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, and/or any other suitable device that is configured to communicate via a wireless medium.

Some UEs 120 may be considered machine-type communication (MTC) or evolved or enhanced machine-type communication (eMTC) UEs. An MTC UE and/or an eMTC UE may include, for example, a robot, a drone, a remote device, a sensor, a meter, a monitor, and/or a location tag, that may communicate with a base station, another device (e.g., a remote device), or some other entity. Some UEs 120 may be considered Internet-of-Things (IoT) devices, and/or may be implemented as NB-IoT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120e) may communicate directly using one or more sidelink channels (e.g., without using a base station 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V21) protocol, or a vehicle-to-pedestrian (V2P) protocol), and/or a mesh network. In such examples, a UE 120 may perform scheduling operations, resource selection operations, and/or other operations described elsewhere herein as being performed by the base station 110.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FR1 (410 MHz-7.125 GHz) and FR2 (24.25 GHz-52.6 GHz). It should be understood that although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHz-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHz, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

In some aspects, the network node may include a communication manager 140 or a communication manager 150. As described in more detail elsewhere herein, the communication manager 140 or 150 may receive a configuration corresponding to one or more channel state information (CSI) report settings associated with a reference signal resource set; and transmit, based at least in part on the configuration, at least one CSI report that indicates a primary set of CSI measurements, of a plurality of CSI measurements associated with the reference signal resource set, and a secondary set of CSI measurements of the plurality of CSI measurements, wherein the plurality of CSI measurements comprises at least one of a physical layer reference signal received power (RSRP) value or a physical layer signal-to-interference-plus-noise ratio (SINR), and wherein the primary set of CSI measurements comprises at least one of a strongest RSRP value or a strongest SINR associated with the plurality of CSI measurements and the secondary set of CSI measurements comprises one or more CSI measurements that are not included in the primary set of CSI measurements. Additionally, or alternatively, the communication manager 140 or 150 may perform one or more other operations described herein.

As described in more detail elsewhere herein, the communication manager 140 or 150 may transmit a configuration corresponding to one or more CSI report settings associated with a reference signal resource set; and receive, based at least in part on the configuration, at least one CSI report that indicates a primary set of CSI measurements, of a plurality of CSI measurements associated with the reference signal resource set, and a secondary set of CSI measurements of the plurality of CSI measurements, wherein the plurality of CSI measurements comprises at least one of a physical layer RSRP value or a physical layer SINR, and wherein the primary set of CSI measurements comprises at least one of a strongest RSRP value or a strongest SINR associated with the plurality of CSI measurements and the secondary set of CSI measurements comprises one or more CSI measurements that are not included in the primary set of CSI measurements. Additionally, or alternatively, the communication manager 140 or 150 may perform one or more other operations described herein.

As described herein, a network node, which may be referred to as a “node,” a “network node,” or a “wireless node,” may be a base station (e.g., base station 110), a UE (e.g., UE 120), a relay device, a network controller, an apparatus, a device, a computing system, one or more components of any of these, and/or another processing entity configured to perform one or more aspects of the techniques described herein. For example, a network node may be a UE. As another example, a network node may be a base station. A network node may be an aggregated base station and/or one or more components of a disaggregated base station. As an example, a first network node may be configured to communicate with a second network node or a third network node. The adjectives “first,” “second,” “third,” and so on are used for contextual distinction between two or more of the modified noun in connection with a discussion and are not meant to be absolute modifiers that apply only to a certain respective node throughout the entire document. For example, a network node may be referred to as a “first network node” in connection with one discussion and may be referred to as a “second network node” in connection with another discussion, or vice versa. Reference to a UE, base station, apparatus, device, computing system, or the like may include disclosure of the UE, base station, apparatus, device, computing system, or the like being a network node. For example, disclosure that a UE is configured to receive information from a base station also discloses that a first network node is configured to receive information from a second network node. Consistent with this disclosure, once a specific example is broadened in accordance with this disclosure (e.g., a UE is configured to receive information from a base station also discloses that a first network node is configured to receive information from a second network node), the broader example of the narrower example may be interpreted in the reverse, but in a broad open-ended way. In the example above where a UE being configured to receive information from a base station also discloses a first network node being configured to receive information from a second network node, “first network node” may refer to a first UE, a first base station, a first apparatus, a first device, a first computing system, a first one or more components, a first processing entity, or the like configured to receive the information from the second network; and “second network node” may refer to a second UE, a second base station, a second apparatus, a second device, a second computing system, a second one or more components, a second processing entity, or the like.

As indicated above, FIG. 1 is provided as an example. Other examples may differ from what is described with regard to FIG. 1.

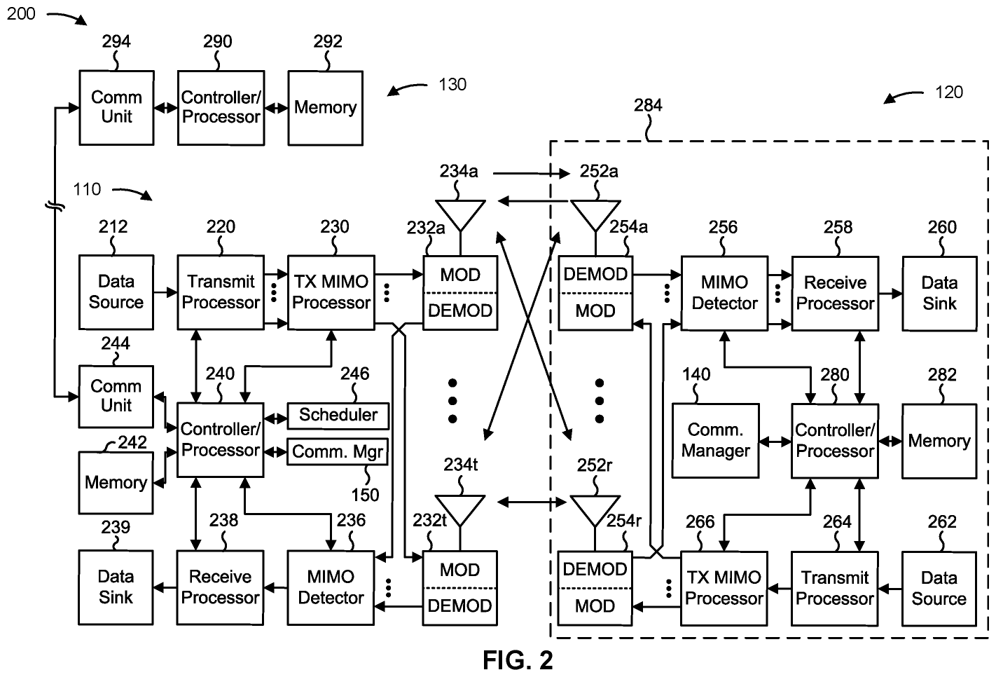

FIG. 2 is a diagram illustrating an example 200 of a base station 110 in communication with a UE 120 in a wireless network 100, in accordance with the present disclosure. The base station 110 may be equipped with a set of antennas 234a through 234t, such as T antennas (T≥1). The UE 120 may be equipped with a set of antennas 252a through 252r, such as R antennas (R≥1).

At the base station 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The base station 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., T output symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

In some aspects, the term “base station” (e.g., the base station 110), “network node,” or “network entity” may refer to an aggregated base station, a disaggregated base station, an integrated access and backhaul (IAB) node, a relay node, and/or one or more components thereof. For example, in some aspects, “base station,” “network node,” or “network entity” may refer to a central unit (CU), a distributed unit (DU), a radio unit (RU), a Near-Real Time (Near-RT) RAN Intelligent Controller (RIC), or a Non-Real Time (Non-RT) RIC, or a combination thereof. In some aspects, the term “base station,” “network node,” or “network entity” may refer to one device configured to perform one or more functions, such as those described herein in connection with the base station 110. In some aspects, the term “base station,” “network node,” or “network entity” may refer to a plurality of devices configured to perform the one or more functions. For example, in some distributed systems, each of a number of different devices (which may be located in the same geographic location or in different geographic locations) may be configured to perform at least a portion of a function, or to duplicate performance of at least a portion of the function, and the term “base station,” “network node,” or “network entity” may refer to any one or more of those different devices. In some aspects, the term “base station,” “network node,” or “network entity” may refer to one or more virtual base stations and/or one or more virtual base station functions. For example, in some aspects, two or more base station functions may be instantiated on a single device. In some aspects, the term “base station,” “network node,” or “network entity” may refer to one of the base station functions and not another. In this way, a single device may include more than one base station.

At the UE 120, a set of antennas 252 (shown as antennas 252a through 252r) may receive the downlink signals from the base station 110 and/or other base stations 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a RSRP parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the base station 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

Each of the antenna elements may include one or more sub-elements for radiating or receiving radio frequency signals. For example, a single antenna element may include a first sub-element cross-polarized with a second sub-element that can be used to independently transmit cross-polarized signals. The antenna elements may include patch antennas, dipole antennas, or other types of antennas arranged in a linear pattern, a two-dimensional pattern, or another pattern. A spacing between antenna elements may be such that signals with a desired wavelength transmitted separately by the antenna elements may interact or interfere (e.g., to form a desired beam). For example, given an expected range of wavelengths or frequencies, the spacing may provide a quarter wavelength, half wavelength, or other fraction of a wavelength of spacing between neighboring antenna elements to allow for interaction or interference of signals transmitted by the separate antenna elements within that expected range.

Antenna elements and/or sub-elements may be used to generate beams. “Beam” may refer to a directional transmission such as a wireless signal that is transmitted in a direction of a receiving device. A beam may include a directional signal, a direction associated with a signal, a set of directional resources associated with a signal (e.g., angle of arrival, horizontal direction, vertical direction), and/or a set of parameters that indicate one or more aspects of a directional signal, a direction associated with a signal, and/or a set of directional resources associated with a signal.

As indicated above, antenna elements and/or sub-elements may be used to generate beams. For example, antenna elements may be individually selected or deselected for transmission of a signal (or signals) by controlling an amplitude of one or more corresponding amplifiers. Beamforming includes generation of a beam using multiple signals on different antenna elements, where one or more, or all, of the multiple signals are shifted in phase relative to each other. The formed beam may carry physical or higher layer reference signals or information. As each signal of the multiple signals is radiated from a respective antenna element, the radiated signals interact, interfere (constructive and destructive interference), and amplify each other to form a resulting beam. The shape (such as the amplitude, width, and/or presence of side lobes) and the direction (such as an angle of the beam relative to a surface of an antenna array) can be dynamically controlled by modifying the phase shifts or phase offsets of the multiple signals relative to each other.

Beamforming may be used for communications between a UE and a base station, such as for millimeter wave communications and/or the like. In such a case, the base station may provide the UE with a configuration of transmission configuration indicator (TCI) states that respectively indicate beams that may be used by the UE, such as for receiving a physical downlink shared channel (PDSCH). The base station may indicate an activated TCJ state to the UE, which the UE may use to select a beam for receiving the PDSCH.

A beam indication may be, or include, a TCJ state information element, a beam identifier (ID), spatial relation information, a TCJ state ID, a closed loop index, a panel ID, a TRP ID, and/or a sounding reference signal (SRS) set ID, among other examples. A TCJ state information element (referred to as a TCJ state herein) may indicate information associated with a beam such as a downlink beam. For example, the TCJ state information element may indicate a TCJ state identification (e.g., a tci-StateID), a quasi-co-location (QCL) type (e.g., a qcl-Type1, qcl-Type2, qcl-TypeA, qcl-TypeB, qcl-TypeC, qcl-TypeD, and/or the like), a cell identification (e.g., a ServCellIndex), a bandwidth part identification (bwp-Id), a reference signal identification such as a channel state information-reference signal (CSI-RS) (e.g., an NZP-CSI-RS-ResourceId, a synchronization signal block (SSB)-Index, and/or the like), and/or the like. Spatial relation information may similarly indicate information associated with an uplink beam.

The beam indication may be a joint or separate downlink (DL)/uplink (UL) beam indication in a unified TCJ framework. In some cases, the network may support layer 1 (L1)-based beam indication using at least UE-specific (unicast) downlink control information (DCI) to indicate joint or separate DL/UL beam indications from active TCI states. In some cases, existing DCI formats 1_1 and/or 1_2 may be reused for beam indication. The network may include a support mechanism for a UE to acknowledge successful decoding of a beam indication. For example, the acknowledgment/negative acknowledgment (ACK/NACK) of the PDSCH scheduled by the DCI carrying the beam indication may be also used as an ACK for the DCI.

Beam indications may be provided for carrier aggregation (CA) scenarios. In a unified TCI framework, information the network may support common TCI state ID update and activation to provide common QCL and/or common UL transmission spatial filter or filters across a set of configured component carriers (CCs). This type of beam indication may apply to intra-band CA, as well as to joint DL/UL and separate DL/UL beam indications. The common TCI state ID may imply that one reference signal (RS) determined according to the TCI state(s) indicated by a common TCI state ID is used to provide QCL Type-D indication and to determine UL transmission spatial filters across the set of configured CCs.

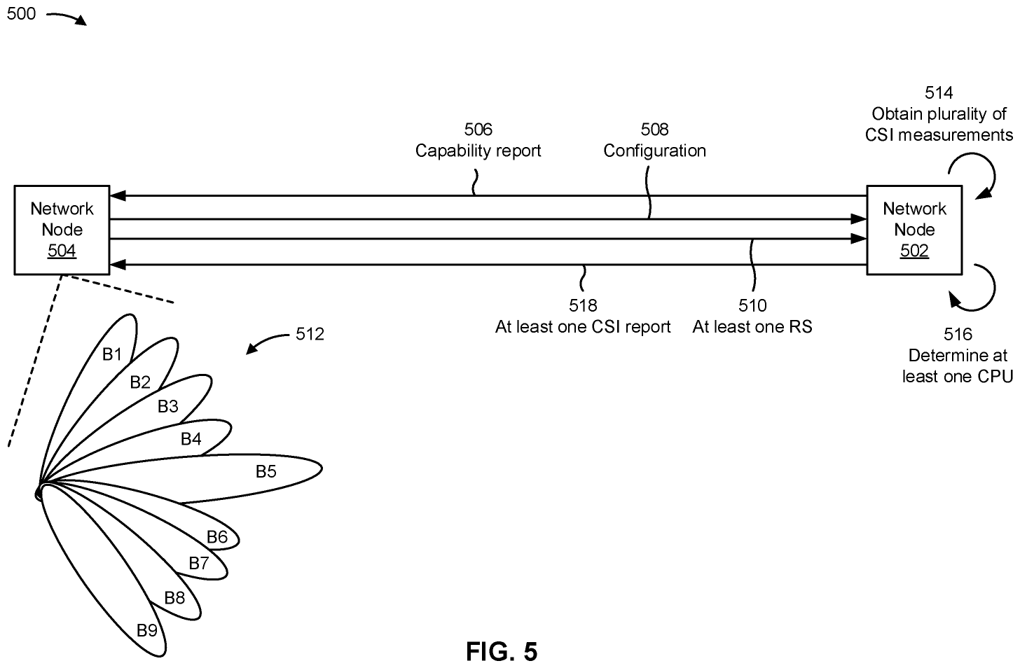

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the base station 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein (e.g., with reference to FIGS. 5-8).

At the base station 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The base station 110 may include a communication unit 244 and may communicate with the network controller 130 via the communication unit 244. The base station 110 may include a scheduler 246 to schedule one or more UEs 120 for downlink and/or uplink communications. In some examples, the modem 232 of the base station 110 may include a modulator and a demodulator. In some examples, the base station 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein (e.g., with reference to FIGS. 5-8).

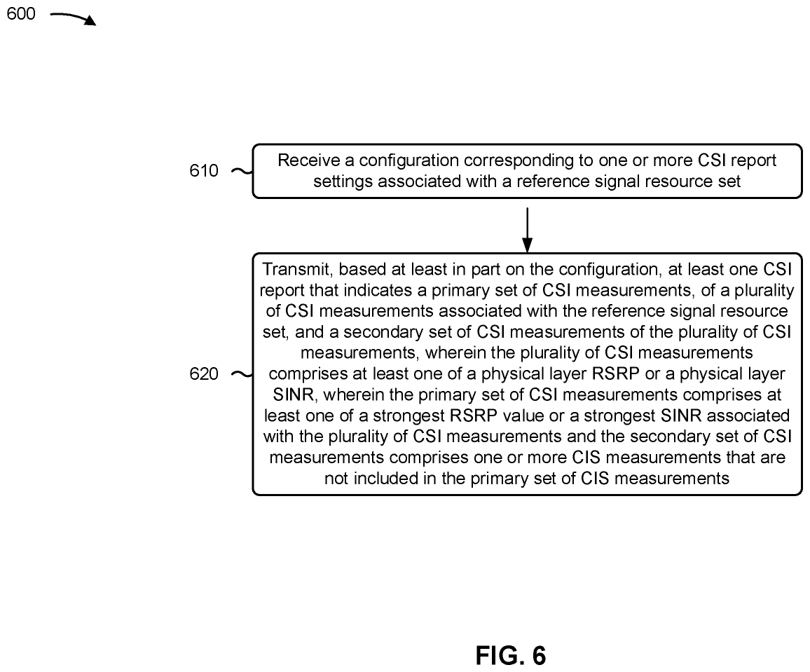

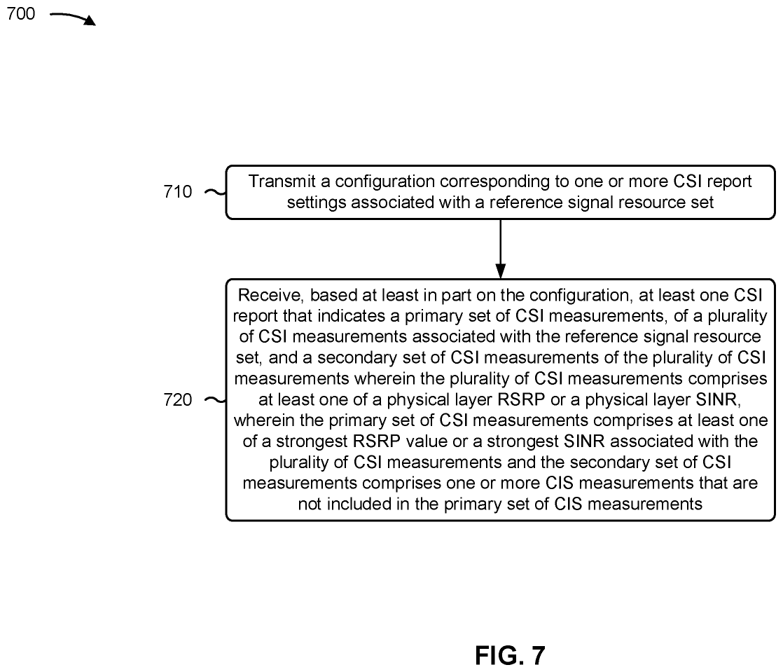

The controller/processor 240 of the base station 110, the controller/processor 280 of the UE 120, and/or any other component(s) of FIG. 2 may perform one or more techniques associated with reporting CSI measurements, as described in more detail elsewhere herein. In some aspects, the network node described herein is the base station 110, is included in the base station 110, or includes one or more components of the base station 110 shown in FIG. 2. In some aspects, the network node described herein is the UE 120, is included in the UE 120, or includes one or more components of the UE 120 shown in FIG. 2. For example, the controller/processor 240 of the base station 110, the controller/processor 280 of the UE 120, and/or any other component(s) of FIG. 2 may perform or direct operations of, for example, process 600 of FIG. 6, process 700 of FIG. 7, and/or other processes as described herein. The memory 242 and the memory 282 may store data and program codes for the base station 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the base station 110 and/or the UE 120, may cause the one or more processors, the UE 120, and/or the base station 110 to perform or direct operations of, for example, process 600 of FIG. 6, process 700 of FIG. 7, and/or other processes as described herein. In some examples, executing instructions may include running the instructions, converting the instructions, compiling the instructions, and/or interpreting the instructions, among other examples.

In some aspects, the network node includes means for receiving a configuration corresponding to one or more CSI report settings associated with a reference signal resource set; and/or means for transmitting, based at least in part on the configuration, at least one CSI report that indicates a primary set of CSI measurements, of a plurality of CSI measurements associated with the reference signal resource set, and a secondary set of CSI measurements of the plurality of CSI measurements, wherein the plurality of CSI measurements comprises at least one of a physical layer RSRP value or a physical layer SINR, and wherein the primary set of CSI measurements comprises at least one of a strongest RSRP value or a strongest SINR associated with the plurality of CSI measurements and the secondary set of CSI measurements comprises one or more CSI measurements that are not included in the primary set of CSI measurements.

In some aspects, the network node includes means for transmitting a configuration corresponding to one or more CSI report settings associated with a reference signal resource set; and/or means for receiving, based at least in part on the configuration, at least one CSI report that indicates a primary set of CSI measurements, of a plurality of CSI measurements associated with the reference signal resource set, and a secondary set of CSI measurements of the plurality of CSI measurements, wherein the plurality of CSI measurements comprises at least one of a physical layer RSRP value or a physical layer SINR, and wherein the primary set of CSI measurements comprises at least one of a strongest RSRP value or a strongest SINR associated with the plurality of CSI measurements and the secondary set of CSI measurements comprises one or more CSI measurements that are not included in the primary set of CSI measurements. In some aspects, the means for the network node to perform operations described herein may include, for example, one or more of communication manager 150, transmit processor 220, TX MIMO processor 230, modem 232, antenna 234, MIMO detector 236, receive processor 238, controller/processor 240, memory 242, or scheduler 246. In some aspects, the means for the network node to perform operations described herein may include, for example, one or more of communication manager 140, antenna 252, modem 254, MIMO detector 256, receive processor 258, transmit processor 264, TX MIMO processor 266, controller/processor 280, or memory 282.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

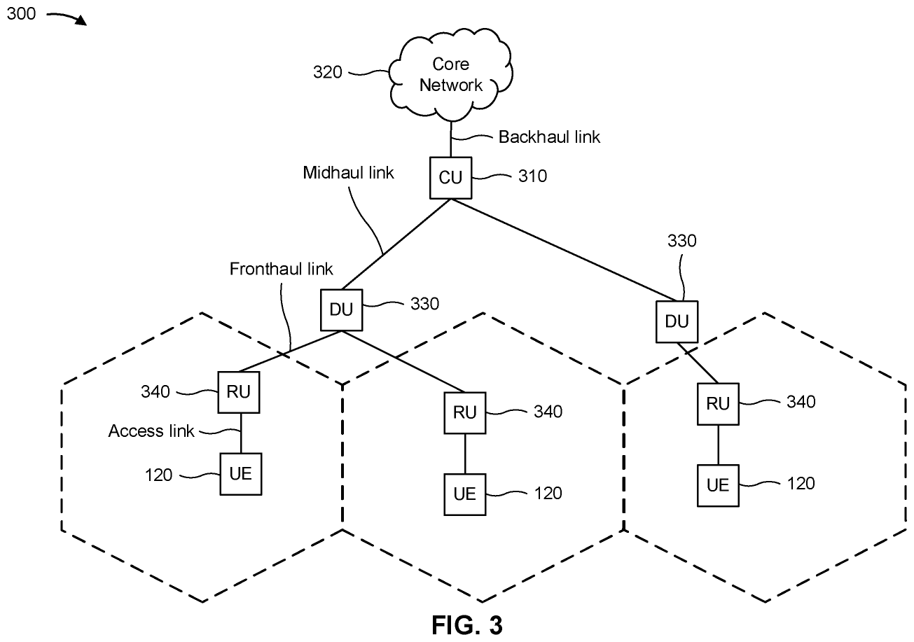

FIG. 3 is a diagram illustrating an example 300 of an O-RAN architecture, in accordance with the present disclosure. As shown in FIG. 3, the O-RAN architecture may include a control unit (CU) 310 that communicates with a core network 320 via a backhaul link. Furthermore, the CU 310 may communicate with one or more DUs 330 via respective midhaul links. The DUs 330 may each communicate with one or more RUs 340 via respective fronthaul links, and the RUs 340 may each communicate with respective UEs 120 via radio frequency (RF) access links. The DUs 330 and the RUs 340 may also be referred to as O-RAN DUs (O-DUs) 330 and O-RAN RUs (O-RUs) 340, respectively.

In some aspects, the DUs 330 and the RUs 340 may be implemented according to a functional split architecture in which functionality of a base station 110 (e.g., an eNB or a gNB) is provided by a DU 330 and one or more RUs 340 that communicate over a fronthaul link. Accordingly, as described herein, a base station 110 may include a DU 330 and one or more RUs 340 that may be co-located or geographically distributed. In some aspects, the DU 330 and the associated RU(s) 340 may communicate via a fronthaul link to exchange real-time control plane information via a lower layer split (LLS) control plane (LLS-C) interface, to exchange non-real-time management information via an LLS management plane (LLS-M) interface, and/or to exchange user plane information via an LLS user plane (LLS-U) interface.

Accordingly, the DU 330 may correspond to a logical unit that includes one or more base station functions to control the operation of one or more RUs 340. For example, in some aspects, the DU 330 may host a radio link control (RLC) layer, a medium access control (MAC) layer, and one or more high physical (PHY) layers (e.g., forward error correction (FEC) encoding and decoding, scrambling, and/or modulation and demodulation) based at least in part on a lower layer functional split. Higher layer control functions, such as a packet data convergence protocol (PDCP), radio resource control (RRC), and/or service data adaptation protocol (SDAP), may be hosted by the CU 310. The RU(s) 340 controlled by a DU 330 may correspond to logical nodes that host RF processing functions and low-PHY layer functions (e.g., fast Fourier transform (FFT), inverse FFT (iFFT), digital beamforming, and/or physical random access channel (PRACH) extraction and filtering) based at least in part on the lower layer functional split. Accordingly, in an O-RAN architecture, the RU(s) 340 handle all over the air (OTA) communication with a UE 120, and real-time and non-real-time aspects of control and user plane communication with the RU(s) 340 are controlled by the corresponding DU 330, which enables the DU(s) 330 and the CU 310 to be implemented in a cloud-based RAN architecture.

As indicated above, FIG. 3 is provided as an example. Other examples may differ from what is described with regard to FIG. 3.

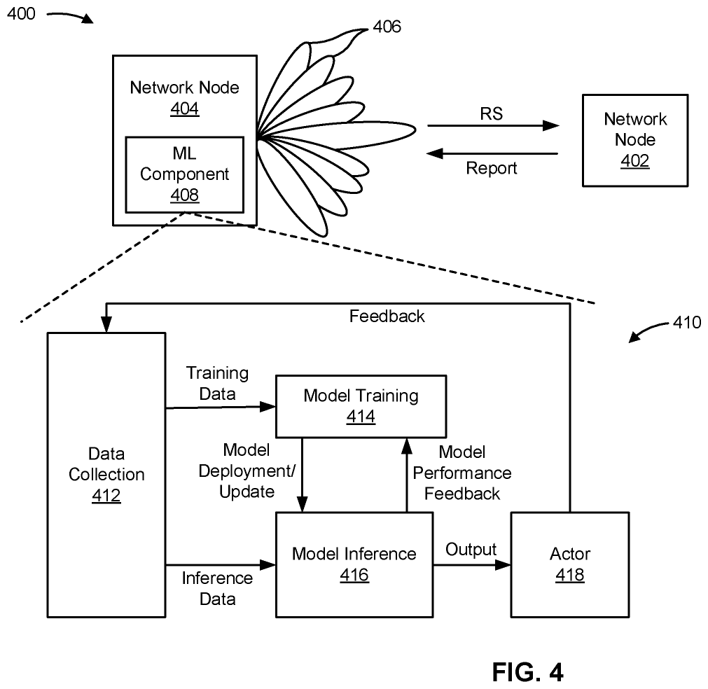

FIG. 4 is a diagram illustrating an example 400 of wireless communications, in accordance with the present disclosure. As shown in FIG. 4, example 400 includes a network node 402 in communication with a network node 404. The network nodes 402 and 404 may communicate via a wireless network (e.g., wireless network 100). In some cases, for example, the network node 402 may be a ULE (e.g., the ULE 120) and the network node 404 may be a base station (e.g., the base station 110). In some cases, the network nodes 402 and 404 may be in a connected state (e.g., an RRC connected state).

The network nodes 402 and 404 may communicate to perform beam management using reference signals. The reference signals may include any number of different types of reference signals such as, for example, SSBs, CSI-RSs, sounding reference signals (SRSs), demodulation reference signals (DMRSs), and/or beam failure detection reference signals (BFD-RSs), among other examples. Beam management may include any number of different procedures related to beams. For example, beam management may include beam sweeping procedures, SSB and random access channel (RACH) association, beam selection procedures, and/or beam refinement procedures, among other examples.

As shown, for example, the network node 404 can transmit a reference signal (shown as “RS”) and the network node 402 can receive the reference signal. The network node 402 can obtain one or more measurements associated with the reference signal and, based on the one or more measurements, can perform a wireless communication task. For example, the network node 402 can transmit a report to the network node 404 that reports the one or more measurements and/or information determined based on the one or more measurements. The network node 402 can adjust a wireless communication parameter based on the one or more measurements. In some cases, the network node 404 can perform one or more wireless communication tasks based on receiving the report from the network node 402.

In some cases, for example, the network node 402 can be configured with one or more parameters for joint SSB resource indicator (SSBRI) and/or CSI-RS resource indicator (CRI) and L1-RSRP and/or L1-SINR beam reporting. In some cases, for example, the network node 402 can be configured to report a set of CSI measurements associated with one or more beams 406. For example, the network node 402 can be configured with parameters ReportQuantity=ssb-Index-RSRP, ssb-Index-SINR, cri-RSRP, and/or cri-SINR. In some cases, the network node 402 can report CSI measurements (e.g., using a parameter nrofReportedRS). The reporting of CSI measurements may be configured (e.g., using a radio resource control (RRC) configuration (RRC)) depending on the capability of the network node 402.

In some cases, for example, the reporting can include physical layer (L1)-RSRP reporting. In some cases, for a strongest SSBRI (e.g., an SSBRI corresponding to a signal strength and/or quality that is greater than the signal strength and/or quality of any other SSBRI that is measured by the network node 402 during a specified time period), seven bits can be used to report a corresponding RSRP (in the range of [−140, −44] dBm with a 1 dBm step size. For remaining SSBRI(s) and/or CRI(s), four bits can be used to report a differential RSRP in the range of [0, −30] dB with a 2 dB step size and a reference to the L1-RSRP of the strongest SSBRI and/or CRI. In some cases, the reporting can include L1-signal-to-interference-plus-noise ratio (L1-SINR). In some cases, for the strongest SSBRI and/or CRI, seven bits can be used to report SINR in the range of [−23, 40] dB with a 0.5 dB step size. For remaining SSBRI(s)/CRI(s), four bits can be used to report a differential SINR in the range of [0, −15] dB with a 1 dB step size and a reference to L1-SINR of the strongest SSBRI/CRI.

As shown in FIG. 4, the network node 404 can include a machine learning (ML) component 408. The ML component may include one or more ML models for facilitating wireless communication tasks. For example, ML models can be used to facilitate determining parameter values associated with measurements. An ML model can be used to estimate a group of parameters (e.g., interference and/or CSI, among other examples) from a common set of inputs (e.g., signal measurements) on current and/or future resources. For example, an ML can jointly estimate the interference and the CSI on future resources using the same input CSI-RS. In another example, an ML model can estimate the interference on multiple future slots and/or symbols using the same input measurements.

In some cases, to develop a machine learning model of the ML component 408, the network node 402 can be configured to collect data and provide the collected data to the ML component 408. The ML component 408 can be configured to implement a functional framework 410 for developing the machine learning model. For example, as shown, the functional framework 410 can include a data collection function (shown as “data collection”) 412, a model training function (shown as “model training”) 414, a model inference function (shown as “model inference”) 416, and an actor function (shown as “actor”) 418. The data collection function 412 can provide training data as input data to the model training function 414 and inference data as input to the model inference function 416. Examples of input data can include measurements from network nodes, feedback from the actor function 418, and/or output from an ML model. In some cases, the data collection function 412 can be configured to simply collect and provide data. For example, in some cases, the data collection function 412 can be configured so that ML algorithm specific data preparation (e.g., data pre-processing, data cleaning, data formatting, and/or transformation, among other examples) is not performed by the data collection function 412.

The model training function 414 can perform ML model training, validation, and/or testing, among other examples. The model training function 414 can also perform data preparation (e.g., data pre-processing, data cleaning, data formatting, and/or transformation, among other examples) based on training data delivered by the data collection function 412. As shown, the model training function 414 can deploy an ML model and/or update of the ML model to the model inference function 416. The model inference function 416 can provide ML model inference output (e.g., predictions, classifications, estimations, and/or decisions, among other examples). In some cases, as shown, the model inference function 416 can provide model performance feedback to the model training function 414. The model inference function 416 can also perform data preparation (e.g., data pre-processing, data cleaning, data formatting, and/or transformation, among other examples) based on inference data delivered by the data collection function 412. The actor function 418 can receive the output from the model inference function 416 and perform one or more wireless communication tasks based on the output. As shown, in some cases, the actor function 418 can provide feedback that can be stored by the data collection function 412 for use as training data and/or inference data.

In some cases, in an ML-model training scheme for spatial and/or time domain beam prediction (e.g., predicting future RSRPs based on observed RSRP series), the network node 404 can collect CSI measurements (e.g., RSRP values and/or SINR values, among other examples) reported by the network node 402 via CSI reports. The CSI measurements can be saved as inputs and/or labels to be used as training data. For example, a series of measured RSRP values can be used as inputs and the outputs can include predicted future RSRP values. The ML model can be trained via supervised learning with labels, which also may include collected RSRP values. However, in some cases, each CSI report can only carry a set of up to four strongest RSRP values. As a result, using reported CSI measurements for ML training can lead to performance degradation. For example, when training an ML model for predicting future RSRP values, the non-observed RSRP values within the input data can only be set to some predetermined values, which can be biased as compared to the actual measured values. As a result, conventional CSI reporting can have a negative impact on ML-based network performance.

Some aspects of the techniques and apparatuses described herein may provide for a more flexible CSI reporting scheme that may facilitate reporting of CSI measurements in addition to the strongest CSI measurements (e.g., RSRP values and/or SINR values). In some aspects, for example, a network node may transmit a CSI reporting configuration to an additional network node that configures the flexible CSI reporting. The network node may transmit one or more reference signals to the additional network node, and the additional network node may obtain one or more CSI measurements based on the one or more reference signals. The additional network node may transmit a CSI report to the network node that indicates a primary set of CSI measurements and a secondary set of CSI measurements. The primary set of CSI measurements may include the strongest CSI measurements (e.g., as reported in a conventional CSI report) and the secondary set of CSI measurements may include CSI measurements other than the strongest CSI measurements. In this manner, the reliability and functionality of conventional CSI reporting may be preserved, while facilitating collection of more robust CSI measurement data for ML training. In some aspects, quantization may be specified in relation to the CSI reporting to facilitate efficiency. As a result, some aspects may facilitate efficient data collection for supporting ML-based wireless communication functions, thereby having a positive impact on ML-based network performance.

As indicated above, FIG. 4 is provided as an example. Other examples may differ from what is described with respect to FIG. 4. For example, in some aspects, one or more of the functions of the functional framework 410 may be implemented by one or more network nodes.

FIG. 5 is a diagram illustrating an example 500 of reporting CSI measurements, in accordance with the present disclosure. As shown in FIG. 5, a network node 502 and a network node 504 may communicate with one another. In some aspects, the network node 502 may be similar to the network node 402 depicted in FIG. 4. In some aspects, the network node 504 may be similar to the network node 404 depicted in FIG. 4. For example, in some aspects, the network node 504 may include an ML component and may be configured to collect data to be used as training data to train one or more ML models.

As shown by reference number 506, the network node 502 may transmit, and the network node 504 may receive, a capability report. The capability report may indicate any number of different capabilities of the network node 502 associated with reporting CSI measurements. For example, in some aspects, the capability report may indicate a maximum quantity of reported CSI measurements that the network node 502 is capable of reporting in a single CSI report. The maximum quantity of reported CSI measurements may include, for example, a sum of a maximum quantity of CSI measurements of a primary set of CSI measurements (e.g., a conventional set nrofReportedRS ofup to four RSRP values and/or SINRs corresponding to the strongest SSBs and/or CSI-RSs) and a maximum quantity of CSI measurements of a secondary set of CSI measurements (e.g., a dedicated set nrofReportedRS DataCollection of RSRP values and/or SINRs other than those in the primary set of CSI measurements). In some aspects, the indication of the maximum quantity of reported CSI measurements that the network node 502 is capable of reporting in a single CSI report may indicate a maximum quantity of CSI measurements of the secondary set of CSI measurements. In some aspects, the capability report may indicate a maximum quantity of CSI processing units (CPUs) associated with at least one CSI report.

As shown by reference number 508, the network node 504 may transmit, and the network node 502 may receive, a configuration. The configuration may correspond to one or more CSI report settings associated with a reference signal resource set. For example, in some aspects, the configuration may configure the network node 502 with the one or more CSI report settings. A CSI report setting may include a set of rules, a set of formats, and/or a set of other information based on which the network node 502 may generate a CSI report. In some aspects, for example, a CSI report setting may be referred to as a “CSI report configuration.” The reference signal resource set may include a CSI-RS resource set and/or an SSB resource set.

As shown by reference number 510, the network node 504 may transmit, and the network node 502 may receive, at least one reference signal. The at least one reference signal may be associated with the reference signal resource set. In some aspects, for example, the network node 504 may transmit the at least one reference signal using at least one beam of a plurality 512 of beams. The plurality 512 of beams (shown as “B1,” . . . “B9”) may include any number of beams. For example, nine beams are shown in example 500, but the plurality 512 of beams may be less than nine or greater than nine. In some aspects, for example, the network node 504 may transmit a reference signal using each beam of the plurality 512 of beams.

As shown by reference number 514, the network node 402 may obtain a plurality of CSI measurements associated with the at least one reference signal. In some aspects, the plurality of CSI measurements may include one or more RSRP values and/or one or more SINRs. For example, the CSI measurements may include an SSB index RSRP, an SSB index SINR, a CRI RSRP, and/or a CRI SINR.

As shown by reference number 516, the network node 502 may determine at least one CPU associated with at least one CSI report. For example, in some aspects, the at least one CPU may correspond to a plurality of CSI reports. In some aspects, the at least one CPU consists of a single CPU corresponding to the plurality of CSI reports. In some aspects, the network node 502 may associate a single CPU with a CSI report of the plurality of CSI reports, where the CSI report corresponds to the primary set of CSI measurements. In some aspects, the number of CPUs may be jointly identified across such multiple CSI reports. For example, a first and second CSI report may account for a single CPU. In some aspects, the second CSI report (and/or additional CSI reports) may not account for CPUs, since the first CSI report already accounts for the CPUs.

As shown by reference number 518, the network node 502 may transmit, and the network node 504 may receive, at least one CSI report. In some aspects, the network node 502 may transmit the at least one CSI report based at least in part on the configuration. In some aspects, the at least one CSI report may indicate a primary set of CSI measurements of the plurality of CSI measurements associated with the reference signal resource set. The at least one CSI report also may indicate a secondary set of CSI measurements of the plurality of CSI measurements. The plurality of CSI measurements may include at least one of a physical layer RSRP value or a physical layer SINR. The primary set of CSI measurements comprises at least one of a strongest RSRP value or a strongest SINR associated with the plurality of CSI measurements.

The secondary set of CSI measurements may include one or more CSI measurements that are not included in the primary set of CSI measurements. The reported CSI measurements may include, for example, at least one of a physical layer RSRP (L1-RSRP) value or a physical layer SINR (L1-SINR).

In some aspects, for example, the network node 502 may be configured, via the configuration, with one or more CSI report settings associated with a single CSI-RS and/or SSB resource set. The report quantity, corresponding to the primary set of CSI measurements, of the CSI report settings may include at least one of an ssb-Index-RSRP, an ssb-Index-SINR, a cri-RSRP, or a cri-SINR (e.g., up to four nrofReportedRS strongest SSBs' and/or CSI-RSs' RSRP values and/or SINRs) associated with the CSI-RS and/or SSB resource set. In addition to reporting the conventional (up to four) nrofReportedRS strongest SSBs' and/or CSI-RSs' RSRP values and/or SINRs, the network node 502 may further report nrofReportedRS DataCollection SSBs' and/or CSI-RSs' RSRP values and/or SINRs associated with the same CSI-RS and/or SSB resource set, where the nrofReportedRS DataCollection SSBs and/or CSI-RSs are different from the (up to four) nrofReportedRS strongest SSBs/CSI-RSs. For example, in some aspects, the at least one CSI report may include a primary set of CSI measurements corresponding to the beams B4, B5, and B6 and a secondary set of CSI measurements corresponding to the beams B1, B2, B3, B7, B8, and B9.

In some aspects, the secondary set of CSI measurements may correspond to a set of reference signals associated with the reference signal resource set, and the set of reference signals may be indicated by at least one of a wireless communication standard or the configuration. A quantity of CSI reports of the at least one CSI report may be indicated by at least one of a wireless communication standard or the configuration. Additionally, in some aspects, a quantization of the at least one CSI report may be indicated by at least one of a wireless communication standard or the configuration.

In some aspects, the at least one CSI report consists of a single CSI report. The one or more CSI report settings may consist of a single CSI report setting corresponding to the single CSI report. The CSI report setting may indicate the primary set of CSI measurements and the secondary set of CSI measurements. For example, the single CSI report setting may include a configuration of the primary set of CSI measurements and a configuration of the secondary set of CSI measurements. In some aspects, the single CSI report setting may include a configuration of the primary set of CSI measurements and a configuration of a difference between a total set of CSI measurements and the primary set of CSI measurements, where the total set of CSI measurements comprises the primary set of CSI measurements and the secondary set of CSI measurements. In some aspects, the network node 502 may transmit the at least one CSI report based at least in part on transmitting a first communication that includes a first part of the single CSI report and transmitting a second communication that includes a second part of the single CSI report. In some aspects, the first part of the single CSI report may include the primary set of CSI measurements and the second part of the single CSI report may include the secondary set of CSI measurements.

In some aspects, the at least one CSI report may include a plurality of CSI reports. The one or more CSI report settings may include a plurality of CSI report settings corresponding to the plurality of CSI reports. For example, the plurality of CSI report settings may include a CSI report setting corresponding to the primary set of CSI measurements and at least one additional CSI report setting corresponding to the secondary set of CSI measurements. In some aspects, a first periodicity corresponding to a first time period between CSI report transmissions may be associated with the CSI report setting and a second periodicity corresponding to a second time period between CSI transmissions may be associated with the at least one additional CSI report setting. The second time period may be longer than the first time period.

In some aspects, the at least one additional CSI report setting may include a plurality of additional CSI report settings, where a total quantity of reference signals in a set of reference signals corresponding to the reference signal resource set, and associated with the plurality of additional CSI report settings, may be no greater than a maximum quantity, indicated in a capability report, of CSI measurements of the secondary set of CSI measurements. In some aspects, a first additional CSI report setting of the plurality of additional CSI report settings may indicate a first subset of reference signals of the set of reference signals, and a second additional CSI report setting of the plurality of additional CSI report settings may indicate a second subset of reference signals of the set of reference signals. The second subset of reference signals may be different than the first subset of reference signals. In some aspects, at least one of an association between the first subset of reference signals and the first additional CSI report setting or an association between the second subset of reference signals and the second additional CSI report setting may be indicated by at least one of a wireless communication standard or the configuration.

In some aspects, the secondary set of CSI measurements may include at least one of a strongest RSRP value or a strongest SINR associated with a remaining set of CSI measurements, where the remaining set of CSI measurements includes each CSI measurement of the plurality of CSI measurements that is not included in the primary set of CSI measurements. For example, in some aspects, the primary set of CSI measurements may include the strongest (up to four) RSRP values and/or SINRs and the remaining set of CSI measurements may include all of the obtained CSI measurements that are not included in the primary set of CSI measurements. In some aspects, the one or more CSI report settings may include a first CSI report setting associated with the primary set of CSI measurements and a second CSI report setting associated with the secondary set of CSI measurements. The first CSI report setting may indicate an index corresponding to the second CSI report setting and at least one rule associated with reporting at least one of a strongest RSRP value or a strongest SINR associated with the remaining set of CSI measurements. In some aspects, the second CSI report setting may indicate an index corresponding to the first CSI report setting and at least one rule associated with reporting the at least one of the strongest RSRP value or the strongest SINR associated with the remaining set of CSI measurements. In some aspects, the configuration may, outside of the CSI report settings, indicate an index corresponding to the first CSI report setting, an index corresponding to the second CSI report setting, and at least one rule associated with reporting the at least one of the strongest RSRP value or the strongest SINR associated with the remaining set of CSI measurements.

In some aspects, the one or more CSI report settings may include a CSI report setting associated with the primary set of CSI measurements and at least one additional CSI report setting associated with the at least one of the strongest RSRP value or the strongest SINR associated with the remaining set of CSI measurements. For example, in some aspects, the strongest RSRP values and/or SINRs may correspond to beams B4, B5, and B6, while a next strongest set of RSRP values and/or SINRs may correspond to beams B2, B3, B7, and B8. The primary set of CSI measurements may be configured by a first CSI report setting associated with beams B4, B5, and B6, while the secondary set of CSI report settings may be configured by a second CSI report setting associated with beams B2, B3, B7, and B8. In some aspects, a third CSI report setting may configure an additional secondary set of CSI measurements associated with beams B1 and B9, which may correspond to a next strongest set of RSRP values and/or SINRs (e.g., a third strongest set of RSRP values and/or SINRs).

In some aspects, for example, the at least one additional CSI report setting may include a first additional CSI report setting associated with a first subset of the at least one of the strongest RSRP value or the strongest SINR associated with the remaining set of CSI measurements, where the first subset of the at least one of the strongest RSRP value or the strongest SINR associated with the remaining set of CSI measurements. The at least one additional CSI report setting may further include a second additional CSI report setting associated with a second subset of the at least one of the strongest RSRP value or the strongest SINR associated with the remaining set of CSI measurements, where the second subset of the at least one of the strongest RSRP value or the strongest SINR associated with the remaining set of CSI measurements comprises at least one of a strongest RSRP value or a strongest SINR associated with an additional remaining set of CSI measurements. The additional remaining set of CSI measurements may include each CSI measurement of the at least one of the strongest RSRP value or the strongest SINR that is not included in the first subset of the at least one of the strongest RSRP value or the strongest SINR associated with the remaining set of CSI measurements.

In some aspects, the CSI report setting may indicate an index corresponding to the at least one additional CSI report setting and at least one rule associated with reporting the at least one of the strongest RSRP value or the strongest SINR associated with the remaining set of CSI measurements. In some aspects, the first additional CSI report setting may indicate an index corresponding to the CSI report setting, an index corresponding to the second additional CSI report setting, and at least one rule associated with reporting the at least one of the strongest RSRP value or the strongest SINR associated with the remaining set of CSI measurements. In some other aspects, the configuration may indicate a first index corresponding to the CSI report setting, a second index corresponding to the first additional CSI report setting, a third index corresponding to the second additional CSI report setting, and an order of the first index, the second index, and the third index based at least in part on a first CSI measurement strength level associated with the CSI report setting, a second CSI measurement strength level associated with the first additional CSI report setting, and a third CSI measurement strength level associated with the second additional CSI report setting.

In some aspects, a first priority associated with a first CSI report setting of the CSI report setting and the at least one additional CSI report setting may be higher than a second priority associated with a second CSI report setting of the CSI report setting and the at least one additional CSI report setting, based at least in part on at least one CSI measurement strength associated with the first CSI report being greater than at least one additional CSI measurement strength associated with the second CSI report. The network node 502 may drop (e.g., not transmit) a CSI report corresponding to the second CSI report setting based at least in part on the first priority being higher than the second priority. In some aspects, a first priority associated with at least one CSI measurement of a single CSI report setting of the CSI report setting and the at least one additional CSI report setting may be higher than a second priority associated with at least one additional CSI measurement of the single CSI report setting based at least in part on at least one measurement strength associated with the at least one CSI measurement being greater than at least one additional measurement strength associated with the at least one additional CSI measurement. The network node 502 may omit, from a single CSI report corresponding to the single CSI report setting, the at least one additional CSI measurement based at least in part on the first priority being higher than the second priority.

In some aspects, a CSI measurement of the secondary set of CSI measurements may be adjacent to a CSI measurement of the primary set of CSI measurements. An adjacent CSI measurement may be, for example, a CSI measurement corresponding to a reference signal ID that is adjacent to a reference signal ID of a CSI measurement of the primary set of CSI measurements. For example, the primary set of CSI measurements may include CSI measurements corresponding to beams B4, B5, and B6, and a CSI measurement corresponding to beam B3 may be adjacent to the CSI measurement corresponding to beam B4. Similarly, a CSI measurement corresponding to beam B7 may be adjacent to the CSI measurement corresponding to beam B6. For example, in some aspects, a first reference signal ID may correspond to the CSI measurement of the secondary set of CSI measurements and a second reference signal ID may correspond to the CSI measurement of the primary set of CSI measurements, where the CSI measurement of the secondary set of CSI measurements is adjacent to the CSI measurement of the primary set of CSI measurements based at least in part on the first reference signal ID being adjacent to the second reference signal ID. In some aspects, the CSI measurement of the secondary set of CSI measurements may be adjacent to the CSI measurement of the primary set of CSI measurements based at least in part on a minimum angular separation between a beam corresponding to the CSI measurement of the primary set of CSI measurements and a beam corresponding to the CSI measurement of the secondary set of CSI measurements.

In some aspects, a quantity of CSI measurements of the primary set of CSI measurements may be equal to a quantity of adjacent CSI measurements of the secondary set of CSI measurements. In some other aspects, a quantity of CSI measurements of the primary set of CSI measurements is not equal to a quantity of adjacent CSI measurements of the secondary set of CSI measurements. A ratio of the quantity of adjacent CSI measurements of the secondary set of CSI measurements to the quantity of CSI measurements of the primary set of CSI measurements may be indicated by at least one of a wireless communication standard or the configuration.

In some aspects, the primary set of CSI measurements may include a first subset of CSI measurements, where the first subset of CSI measurements includes at least one of a strongest RSRP value or a strongest SINR associated with the primary set of CSI measurements, and a second subset of CSI measurements, where the second subset of CSI measurements comprises at least one of a strongest RSRP value or a strongest SINR associated with a remaining subset of CSI measurements of the primary set of CSI measurements, the remaining subset of CSI measurements comprising each CSI measurement of the primary set of CSI measurements that is not included in the first subset of CSI measurements. The configuration may indicate a first quantity of adjacent CSI measurements, of the secondary set of CSI measurements, associated with the first subset of CSI measurements and a second quantity of adjacent CSI measurements, of the secondary set of CSI measurements, associated with the second subset of CSI measurements.

In some aspects, for example, the network node 502 may identify a plurality of adjacent CSI measurements of the plurality of CSI measurements, determine that a quantity of adjacent CSI measurements of the plurality of adjacent CSI measurements satisfies a measurement quantity threshold, and determine, based at least in part on determining that the quantity of adjacent CSI measurements satisfies the measurement threshold, that at least one reference signal ID corresponding to at least one adjacent CSI measurement, of the plurality of adjacent CSI measurements, satisfies a reference signal ID condition. The secondary set of CSI measurements may include the at least one adjacent CSI measurement based at least in part on the determination that the at least one reference signal ID satisfies the reference signal ID condition.

Determining that the at least one reference signal ID satisfies the reference signal ID condition may include, for example, determining that the at least one reference signal ID has a value that is less than at least one additional value of at least one additional reference signal ID corresponding to at least one additional adjacent CSI measurement of the plurality of adjacent CSI measurements. In some aspects, determining that the at least one reference signal ID satisfies the reference signal ID condition may include determining that the at least one reference signal ID has a value that is greater than at least one additional value of at least one additional reference signal ID corresponding to at least one additional adjacent CSI measurement of the plurality of adjacent CSI measurements. The at least one CSI report may indicate a set of reference signal IDs corresponding to the primary set of CSI measurements but may omit reference signal IDs corresponding to any adjacent CSI measurements, as the network node 404 may ascertain, based on the configuration, that any other reported CSI measurements are adjacent CSI measurements.

In some aspects, for example, the at least one adjacent CSI measurement may include a first adjacent CSI measurement, where a value of a first reference signal ID corresponding to the first adjacent CSI measurement is one greater than a value of a second reference signal ID corresponding to a CSI measurement of the primary set of CSI measurements, and a second adjacent CSI measurement, where a value of a third reference signal ID corresponding to the second adjacent CSI measurement is one less than a value of the second reference signal ID. In some other aspects, the at least one CSI report may include a first indication of an adjacent CSI measurement of the at least one adjacent CSI measurement, where a value of a first reference signal ID corresponding to the adjacent CSI measurement is one greater than a value of a second reference signal ID corresponding to a CSI measurement of the primary set of CSI measurements or one less than the value of a second reference signal ID corresponding to a CSI measurement of the primary set of CSI measurements, and a second indication of the adjacent CSI measurement.

In some aspects (e.g., wherein the adjacent CSI measurement is associated with a beam in one angular direction from a primary CSI measurement such as, for example, where the primary CSI measurement corresponds to the beam B8 and the adjacent CSI measurement corresponds to the beam B9), the at least one CSI report may include only one indication of an adjacent CSI measurement of the at least one adjacent CSI measurement. A value of a first reference signal ID corresponding to the adjacent CSI measurement may be one greater than a value of a second reference signal ID corresponding to a CSI measurement of the primary set of CSI measurements or one less than the value of a second reference signal ID corresponding to a CSI measurement of the primary set of CSI measurements. In some aspects, the at least one CSI report may include the only one indication of the adjacent CSI measurement based at least in part on a payload size associated with the at least one CSI report.

As described above, the network node 502 may use any number of quantization methods for reporting the CSI measurements. For example, in some aspects, the network node 502 may transmit the at least one CSI report based at least in part on performing a quantization method associated with the primary set of CSI measurements and performing at least one additional quantization method associated with the secondary set of CSI measurements. The network node 502 may perform the at least one additional quantization method based at least in part on differentially reporting a CSI measurement of the secondary set of CSI measurements based at least in part on a relative CSI measurement strength associated with a CSI measurement of the primary set of CSI measurements. In some aspects, the network node 502 may perform the at least one additional quantization method based at least in part on differentially reporting at least one CSI measurement of a first subset of the secondary set of CSI measurements relative to at least one CSI measurement of the primary set of CSI measurements, and differentially reporting at least one CSI measurement of a second subset of the secondary set of CSI measurements relative to the at least one CSI measurement of the first subset.

In some aspects, the network node 502 may differentially report the at least one CSI measurement of the second subset based at least in part on differentially reporting the at least one CSI measurement of the second subset based at least in part on a relative CSI measurement strength associated with the at least one CSI measurement of the first subset. The network node 502 may perform at least one additional quantization method associated with the secondary set of CSI measurements based at least in part on differentially reporting a CSI measurement of the secondary set of CSI measurements relative to an adjacent CSI measurement of the primary set of CSI measurements. In some aspects, the network node 502 may transmit the at least one CSI report based at least in part on performing a quantization method associated with the primary set of CSI measurements based at least in part on a quantization parameter value, and performing at least one additional quantization method associated with the secondary set of CSI measurements based at least in part on at least one additional quantization parameter value, wherein the at least one additional quantization parameter value is different than the quantization parameter value. In some aspects, the quantization parameter value may indicate at least one of a quantization step size or a dynamic range.

As indicated above, FIG. 5 is provided as an example. Other examples may differ from what is described with respect to FIG. 5. For example, in some aspects, any number of different quantization methods may be used for reporting CSI measurements.

FIG. 6 is a diagram illustrating an example process 600 performed, for example, by a network node, in accordance with the present disclosure. Example process 600 is an example where the network node (e.g., network node 502) performs operations associated with reporting CSI measurements.

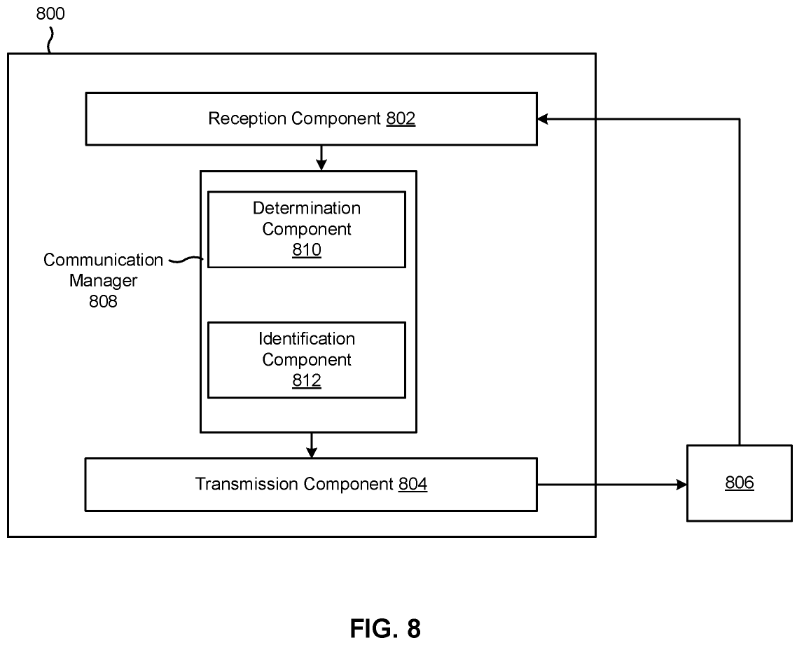

As shown in FIG. 6, in some aspects, process 600 may include receiving a configuration corresponding to one or more CSI report settings associated with a reference signal resource set (block 610). For example, the network node (e.g., using communication manager 808 and/or reception component 802, depicted in FIG. 8) may receive a configuration corresponding to one or more CSI report settings associated with a reference signal resource set, as described above.

As further shown in FIG. 6, in some aspects, process 600 may include transmitting, based at least in part on the configuration, at least one CSI report that indicates a primary set of CSI measurements, of a plurality of CSI measurements associated with the reference signal resource set, and a secondary set of CSI measurements of the plurality of CSI measurements, wherein the plurality of CSI measurements comprises at least one of a physical layer RSRP value or a physical layer SINR, and wherein the primary set of CSI measurements comprises at least one of a strongest RSRP value or a strongest SINR associated with the plurality of CSI measurements and the secondary set of CSI measurements comprises one or more CSI measurements that are not included in the primary set of CSI measurements (block 620).

For example, the network node (e.g., using communication manager 808 and/or transmission component 804, depicted in FIG. 8) may transmit, based at least in part on the configuration, at least one CSI report that indicates a primary set of CSI measurements, of a plurality of CSI measurements associated with the reference signal resource set, and a secondary set of CSI measurements of the plurality of CSI measurements, wherein the plurality of CSI measurements comprises at least one of a physical layer RSRP value or a physical layer SINR, and wherein the primary set of CSI measurements comprises at least one of a strongest RSRP value or a strongest SINR associated with the plurality of CSI measurements and the secondary set of CSI measurements comprises one or more CSI measurements that are not included in the primary set of CSI measurements R, as described above.

Process 600 may include additional aspects, such as any single aspect or any combination of aspects described below and/or in connection with one or more other processes described elsewhere herein.

In a first aspect, the reference signal resource set comprises at least one of a CSI-RS resource set, or a synchronization signal block (SSB) resource set. In a second aspect, alone or in combination with the first aspect, the plurality of CSI measurements comprises at least one of an SSB index RSRP, an SSB index SINR, a CSI-RS resource indicator (CRI) RSRP, or a CRI SINR. In a third aspect, alone or in combination with one or more of the first and second aspects, the secondary set of CSI measurements corresponds to a set of reference signals associated with the reference signal resource set, and the set of reference signals is indicated by at least one of a wireless communication standard or the configuration. In a fourth aspect, alone or in combination with one or more of the first through third aspects, a quantity of CSI reports of the at least one CSI report is indicated by at least one of a wireless communication standard or the configuration. In a fifth aspect, alone or in combination with one or more of the first through fourth aspects, a quantization of the at least one CSI report is indicated by at least one of a wireless communication standard or the configuration.

In a sixth aspect, alone or in combination with one or more of the first through fifth aspects, the at least one CSI report consists of a single CSI report. In a seventh aspect, alone or in combination with the sixth aspect, process 600 includes transmitting a capability report that indicates a maximum quantity of reported CSI measurements that the network node is capable of reporting in the single CSI report, the maximum quantity of reported CSI measurements comprising a sum of a maximum quantity of CSI measurements of the primary set of CSI measurements and a maximum quantity of CSI measurements of the secondary set of CSI measurements. In an eighth aspect, alone or in combination with one or more of the sixth or seventh aspects, process 600 includes transmitting a capability report comprising an indication of a maximum quantity of reported CSI measurements that the network node is capable of reporting in the single CSI report, wherein the indication indicates a maximum quantity of CSI measurements of the secondary set of CSI measurements.

In a ninth aspect, alone or in combination with one or more of the sixth through eighth aspects, the one or more CSI report settings consists of a single CSI report setting corresponding to the single CSI report, the CSI report setting indicating the primary set of CSI measurements and the secondary set of CSI measurements. In a tenth aspect, alone or in combination with the ninth aspect, the single CSI report setting comprises a configuration of the primary set of CSI measurements and a configuration of the secondary set of CSI measurements. In an eleventh aspect, alone or in combination with the ninth aspect, the single CSI report setting comprises a configuration of the primary set of CSI measurements, and a configuration of a difference between a total set of CSI measurements and the primary set of CSI measurements, wherein the total set of CSI measurements comprises the primary set of CSI measurements and the secondary set of CSI measurements.

In a twelfth aspect, alone or in combination with one or more of the sixth through eleventh aspects, transmitting the at least one CSI report comprises transmitting a first communication comprising a first part of the single CSI report, and transmitting a second communication comprising a second part of the single CSI report. In a thirteenth aspect, alone or in combination with the twelfth aspect, the first part of the single CSI report includes the primary set of CSI measurements, and the second part of the single CSI report includes the secondary set of CSI measurements.

In a fourteenth aspect, alone or in combination with one or more of the first through thirteenth aspects, the at least one CSI report comprises a plurality of CSI reports. In a fifteenth aspect, alone or in combination with the fourteenth aspect, the one or more CSI report settings comprises a plurality of CSI report settings corresponding to the plurality of CSI reports. In a sixteenth aspect, alone or in combination with the fifteenth aspect, process 600 includes transmitting a capability report that indicates a maximum quantity of reported CSI measurements that the network node is capable of reporting in the plurality of CSI reports, the maximum quantity of reported CSI measurements comprising a maximum quantity of CSI measurements of the secondary set of CSI measurements, wherein the plurality of CSI report settings are based at least in part on the capability report.

In a seventeenth aspect, alone or in combination with one or more of the fifteenth or sixteenth aspects, the plurality of CSI report settings include a CSI report setting corresponding to the primary set of CSI measurements, and at least one additional CSI report setting corresponding to the secondary set of CSI measurements. In an eighteenth aspect, alone or in combination with the seventeenth aspect, a first periodicity corresponding to a first time period between CSI report transmissions is associated with the CSI report setting, and a second periodicity corresponding to a second time period between CSI transmissions is associated with the at least one additional CSI report setting, wherein the second time period is longer than the first time period.

In a nineteenth aspect, alone or in combination with one or more of the seventeenth or eighteenth aspects, the at least one additional CSI report setting comprises a plurality of additional CSI report settings, wherein a total quantity of reference signals in a set of reference signals corresponding to the reference signal resource set, and associated with the plurality of additional CSI report settings, is no greater than a maximum quantity, indicated in a capability report, of CSI measurements of the secondary set of CSI measurements. In a twentieth aspect, alone or in combination with the nineteenth aspect, a first additional CSI report setting of the plurality of additional CSI report settings indicates a first subset of reference signals of the set of reference signals, and a second additional CSI report setting of the plurality of additional CSI report settings indicates a second subset of reference signals of the set of reference signals, wherein the second subset of reference signals is different than the first subset of reference signals. In a twenty-first aspect, alone or in combination with the twentieth aspect, at least one of an association between the first subset of reference signals and the first additional CSI report setting or an association between the second subset of reference signals and the second additional CSI report setting is indicated by at least one of a wireless communication standard or the configuration.

In a twenty-second aspect, alone or in combination with one or more of the fourteenth through twenty-first aspects, process 600 includes determining at least one CPU associated with the plurality of CSI reports. In a twenty-third aspect, alone or in combination with the twenty-second aspect, the at least one CPU consists of a single CPU corresponding to the plurality of CSI reports. In a twenty-fourth aspect, alone or in combination with the twenty-third aspect, process 600 includes associating the single CPU with a CSI report of the plurality of CSI reports, wherein the CSI report corresponds to the primary set of CSI measurements. In a twenty-fifth aspect, alone or in combination with one or more of the fourteenth through twenty-fourth aspects, process 600 includes transmitting a capability report that indicates a maximum quantity of CPUs associated with the plurality of CSI reports.

In a twenty-sixth aspect, alone or in combination with one or more of the first through twenty-fifth aspects, the secondary set of CSI measurements comprises at least one of a strongest RSRP value or a strongest SINR associated with a remaining set of CSI measurements, the remaining set of CSI measurements comprising each CSI measurement of the plurality of CSI measurements that is not included in the primary set of CSI measurements. In a twenty-seventh aspect, alone or in combination with the twenty-sixth aspect, the one or more CSI report settings comprises a first CSI report setting associated with the primary set of CSI measurements, and a second CSI report setting associated with the secondary set of CSI measurements, the first CSI report setting indicating an index corresponding to the second CSI report setting, and the first CSI report setting indicates at least one rule associated with reporting the at least one of the strongest RSRP value of the strongest SINRassociated with the remaining set of CSI measurements. In a twenty-eighth aspect, alone or in combination with the twenty-sixth aspect, the one or more CSI report settings comprises a first CSI report setting associated with the primary set of CSI measurements, and a second CSI report setting associated with the secondary set of CSI measurements, the second CSI report setting indicating an index corresponding to the first CSI report setting, and the second CSI report setting indicates at least one rule associated with reporting the at least one of the strongest RSRP value or the strongest SINR associated with the remaining set of CSI measurements. In a twenty-ninth aspect, alone or in combination with the twenty-sixth aspect, the one or more CSI report settings comprises a first CSI report setting and a second CSI report setting, and the configuration indicates an index corresponding to the first CSI report setting, an index corresponding to the second CSI report setting, and at least one rule associated with reporting the at least one of the strongest RSRP value or the strongest SINR associated with the remaining set of CSI measurements.

In a thirtieth aspect, alone or in combination with one or more of the twenty-sixth through twenty-ninth aspects, the one or more CSI report settings comprises a CSI report setting associated with the primary set of CSI measurements, and at least one additional CSI report setting associated with of the at least one of the strongest RSRP value or the strongest SINR associated with the remaining set of CSI measurements. In a thirty-first aspect, alone or in combination with the thirtieth aspect, the at least one additional CSI report setting comprises a first additional CSI report setting associated with a first subset of the at least one of the strongest RSRP value or the strongest SINR associated with the remaining set of CSI measurements, wherein the first subset of the at least one of the strongest RSRP value or the strongest SINR associated with the remaining set of CSI measurements comprises at least one of a strongest RSRP value or a strongest SINR associated with the at least one of the strongest RSRP value or the strongest SINR associated with the remaining set of CSI measurements, and a second additional CSI report setting associated with a second subset of the at least one of the strongest RSRP value or the strongest SINR associated with the remaining set of CSI measurements, wherein the second subset of the at least one of the strongest RSRP value or the strongest SINR associated with the remaining set of CSI measurements comprises at least one of a strongest RSRP value or a strongest SINR associated with an additional remaining set of CSI measurements, the additional remaining set of CSI measurements comprising each CSI measurement of the at least one of the strongest RSRP value or the strongest SINR that is not included in the first subset of the at least one of the strongest RSRP value or the strongest SINR associated with the remaining set of CSI measurements.

In a thirty-second aspect, alone or in combination with the thirty-first aspect, the CSI report setting indicates an index corresponding to the at least one additional CSI report setting, and at least one rule associated with reporting the at least one of the strongest RSRP value or the strongest SINR associated with the remaining set of CSI measurements. In a thirty-third aspect, alone or in combination with the thirty-first aspect, the first additional CSI report setting indicates an index corresponding to the CSI report setting, an index corresponding to the second additional CSI report setting, and at least one rule associated with reporting the at least one of the strongest RSRP value or the strongest SINR associated with the remaining set of CSI measurements. In a thirty-fourth aspect, alone or in combination with the thirty-first aspect, the configuration indicates a first index corresponding to the CSI report setting, a second index corresponding to the first additional CSI report setting, a third index corresponding to the second additional CSI report setting, and an order of the first index, the second index, and the third index based at least in part on a first CSI measurement strength level associated with the CSI report setting, a second CSI measurement strength level associated with the first additional CSI report setting, and a third CSI measurement strength level associated with the second additional CSI report setting.

In a thirty-fifth aspect, alone or in combination with the thirtieth aspect, a first priority associated with a first CSI report setting of the CSI report setting and the at least one additional CSI report setting is higher than a second priority associated with a second CSI report setting of the CSI report setting and the at least one additional CSI report setting based at least in part on at least one CSI measurement strength associated with the first CSI report being greater than at least one additional CSI measurement strength associated with the second CSI report. In a thirty-sixth aspect, alone or in combination with the thirty-fifth aspect, process 600 includes dropping a CSI report corresponding to the second CSI report setting based at least in part on the first priority being higher than the second priority. In a thirty-seventh aspect, alone or in combination with one or more of the thirtieth through thirty-sixth aspects, a first priority associated with at least one CSI measurement of a single CSI report setting of the CSI report setting and the at least one additional CSI report setting is higher than a second priority associated with at least one additional CSI measurement of the single CSI report setting based at least in part on at least one measurement strength associated with the at least one CSI measurement being greater than at least one additional measurement strength associated with the at least one additional CSI measurement. In a thirty-eighth aspect, alone or in combination with the thirty-seventh aspect, process 600 includes omitting, from a single CSI report corresponding to the single CSI report setting, the at least one additional CSI measurement based at least in part on the first priority being higher than the second priority.

In a thirty-ninth aspect, alone or in combination with one or more of the first through thirty-eighth aspects, a CSI measurement of the secondary set of CSI measurements is adjacent to a CSI measurement of the primary set of CSI measurements. In a fortieth aspect, alone or in combination with the thirty-ninth aspect, a first reference signal ID corresponds to the CSI measurement of the secondary set of CSI measurements and a second reference signal ID corresponds to the CSI measurement of the primary set of CSI measurements, and the CSI measurement of the secondary set of CSI measurements is adjacent to the CSI measurement of the primary set of CSI measurements based at least in part on the first reference signal ID being adjacent to the second reference signal ID. In a forty-first aspect, alone or in combination with one or more of the thirty-ninth or fortieth aspects, the CSI measurement of the secondary set of CSI measurements is adjacent to the CSI measurement of the primary set of CSI measurements based at least in part on a minimum angular separation between a beam corresponding to the CSI measurement of the primary set of CSI measurements and a beam corresponding to the CSI measurement of the secondary set of CSI measurements.

In a forty-second aspect, alone or in combination with one or more of the first through forty-first aspects, a quantity of CSI measurements of the primary set of CSI measurements is equal to a quantity of adjacent CSI measurements of the secondary set of CSI measurements. In a forty-third aspect, alone or in combination with one or more of the first through forty-second aspects, a quantity of CSI measurements of the primary set of CSI measurements is not equal to a quantity of adjacent CSI measurements of the secondary set of CSI measurements. In a forty-fourth aspect, alone or in combination with the forty-third aspect, a ratio of the quantity of adjacent CSI measurements of the secondary set of CSI measurements to the quantity of CSI measurements of the primary set of CSI measurements is indicated by at least one of a wireless communication standard or the configuration. In a forty-fifth aspect, alone or in combination with one or more of the forty-third or forty-fourth aspects, the primary set of CSI measurements comprises a first subset of CSI measurements, wherein the first subset of CSI measurements comprises at least one of a strongest RSRP value or a strongest SINR associated with the primary set of CSI measurements, and a second subset of CSI measurements, wherein the second subset of CSI measurements comprises at least one of a strongest RSRP value or a strongest SINR associated with a remaining subset of CSI measurements of the primary set of CSI measurements, the remaining subset of CSI measurements comprising each CSI measurement of the primary set of CSI measurements that is not included in the first subset of CSI measurements. In a forty-sixth aspect, alone or in combination with the forty-fifth aspect, the configuration indicates a first quantity of adjacent CSI measurements, of the secondary set of CSI measurements, associated with the first subset of CSI measurements, and a second quantity of adjacent CSI measurements, of the secondary set of CSI measurements, associated with the second subset of CSI measurements.

In a forty-seventh aspect, alone or in combination with one or more of the first through forty-sixth aspects, process 600 includes identifying a plurality of adjacent CSI measurements of the plurality of CSI measurements, determining that a quantity of adjacent CSI measurements of the plurality of adjacent CSI measurements satisfies a measurement quantity threshold, and determining, based at least in part on determining that the quantity of adjacent CSI measurements satisfies the measurement threshold, that at least one reference signal ID corresponding to at least one adjacent CSI measurement, of the plurality of adjacent CSI measurements, satisfies a reference signal ID condition, wherein the secondary set of CSI measurements comprises the at least one adjacent CSI measurement based at least in part on determining that the at least one reference signal ID satisfies the reference signal ID condition. In a forty-eighth aspect, alone or in combination with the forty-seventh aspect, determining that the at least one reference signal ID satisfies the reference signal ID condition comprises determining that the at least one reference signal ID has a value that is less than at least one additional value of at least one additional reference signal ID corresponding to at least one additional adjacent CSI measurement of the plurality of adjacent CSI measurements. In a forty-ninth aspect, alone or in combination with the forty-seventh aspect, determining that the at least one reference signal ID satisfies the reference signal ID condition comprises determining that the at least one reference signal ID has a value that is greater than at least one additional value of at least one additional reference signal ID corresponding to at least one additional adjacent CSI measurement of the plurality of adjacent CSI measurements.

In a fiftieth aspect, alone or in combination with one or more of the forty-seventh through forty-ninth aspects, the at least one CSI report indicates a set of reference signal IDs corresponding to the primary set of CSI measurements. In a fifty-first aspect, alone or in combination with the fiftieth aspect, the at least one CSI report does not indicate a reference signal ID corresponding to the at least one adjacent CSI measurement. In a fifty-second aspect, alone or in combination with the fifty-first aspect, the at least one adjacent CSI measurement comprises a first adjacent CSI measurement, wherein a value of a first reference signal ID corresponding to the first adjacent CSI measurement is one greater than a value of a second reference signal ID corresponding to a CSI measurement of the primary set of CSI measurements, and a second adjacent CSI measurement, wherein a value of a third reference signal ID corresponding to the second adjacent CSI measurement is one less than a value of the second reference signal ID.

In a fifty-third aspect, alone or in combination with the fifty-second aspect, the at least one CSI report comprises a first indication of an adjacent CSI measurement of the at least one adjacent CSI measurement, wherein a value of a first reference signal ID corresponding to the adjacent CSI measurement is one greater than a value of a second reference signal ID corresponding to a CSI measurement of the primary set of CSI measurements or one less than the value of a second reference signal ID corresponding to a CSI measurement of the primary set of CSI measurements, and a second indication of the adjacent CSI measurement. In a fifty-fourth aspect, alone or in combination with the fifty-second aspect, the at least one CSI report comprises only one indication of an adjacent CSI measurement of the at least one adjacent CSI measurement, wherein a value of a first reference signal ID corresponding to the adjacent CSI measurement is one greater than a value of a second reference signal ID corresponding to a CSI measurement of the primary set of CSI measurements or one less than the value of a second reference signal ID corresponding to a CSI measurement of the primary set of CSI measurements. In a fifty-fifth aspect, alone or in combination with the fifty-fourth aspect, the at least one CSI report comprises the only one indication of the adjacent CSI measurement based at least in part on a payload size associated with the at least one CSI report.

In a fifty-sixth aspect, alone or in combination with one or more of the first through fifty-fifth aspects, transmitting the at least one CSI report comprises performing a quantization method associated with the primary set of CSI measurements, and performing at least one additional quantization method associated with the secondary set of CSI measurements. In a fifty-seventh aspect, alone or in combination with the fifty-sixth aspect, performing the at least one additional quantization method comprises differentially reporting a CSI measurement of the secondary set of CSI measurements based at least in part on a relative CSI measurement strength associated with a CSI measurement of the primary set of CSI measurements. In a fifty-eighth aspect, alone or in combination with the fifty-sixth aspect, performing the at least one additional quantization method comprises differentially reporting at least one CSI measurement of a first subset of the secondary set of CSI measurements relative to at least one CSI measurement of the primary set of CSI measurements, and differentially reporting at least one CSI measurement of a second subset of the secondary set of CSI measurements relative to the at least one CSI measurement of the first subset. In a fifty-ninth aspect, alone or in combination with the fifty-eighth aspect, differentially reporting the at least one CSI measurement of the second subset comprises differentially reporting the at least one CSI measurement of the second subset based at least in part on a relative CSI measurement strength associated with the at least one CSI measurement of the first subset. In a sixtieth aspect, alone or in combination the fifty-sixth aspect, performing at least one additional quantization method associated with the secondary set of CSI measurements comprises differentially reporting a CSI measurement of the secondary set of CSI measurements relative to an adjacent CSI measurement of the primary set of CSI measurements.

In a sixty-first aspect, alone or in combination with one or more of the first through sixtieth aspects, transmitting the at least one CSI report comprises performing a quantization method associated with the primary set of CSI measurements based at least in part on a quantization parameter value, and performing at least one additional quantization method associated with the secondary set of CSI measurements based at least in part on at least one additional quantization parameter value, wherein the at least one additional quantization parameter value is different than the quantization parameter value. In a sixty-second aspect, alone or in combination with the sixty-first aspect, the quantization parameter value indicates at least one of a quantization step size or a dynamic range.

Although FIG. 6 shows example blocks of process 600, in some aspects, process 600 may include additional blocks, fewer blocks, different blocks, or differently arranged blocks than those depicted in FIG. 6. Additionally, or alternatively, two or more of the blocks of process 600 may be performed in parallel.

FIG. 7 is a diagram illustrating an example process 700 performed, for example, by a network node, in accordance with the present disclosure. Example process 700 is an example where the network node (e.g., network node 504) performs operations associated with reporting CSI measurements.

As shown in FIG. 7, in some aspects, process 700 may include transmitting a configuration corresponding to one or more CSI report settings associated with a reference signal resource set (block 710). For example, the network node (e.g., using communication manager 808 and/or transmission component 804, depicted in FIG. 8) may transmit a configuration corresponding to one or more CSI report settings associated with a reference signal resource set, as described above.

As further shown in FIG. 7, in some aspects, process 700 may include receiving, based at least in part on the configuration, at least one CSI report that indicates a primary set of CSI measurements, of a plurality of CSI measurements associated with the reference signal resource set, and a secondary set of CSI measurements of the plurality of CSI measurements, wherein the plurality of CSI measurements comprises at least one of a physical layer reference signal RSRP value or a physical layer SINR, and wherein the primary set of CSI measurements comprises at least one of a strongest RSRP value or a strongest SINR associated with the plurality of CSI measurements and the secondary set of CSI measurements comprises one or more CSI measurements that are not included in the primary set of CSI measurements (block 720). For example, the network node (e.g., using communication manager 808 and/or reception component 802, depicted in FIG. 8) may receive, based at least in part on the configuration, at least one CSI report that indicates a primary set of CSI measurements, of a plurality of CSI measurements associated with the reference signal resource set, and a secondary set of CSI measurements of the plurality of CSI measurements, wherein the plurality of CSI measurements comprises at least one of a physical layer reference signal RSRP value or a physical layer SINR, and wherein the primary set of CSI measurements comprises at least one of a strongest RSRP value or a strongest SINR associated with the plurality of CSI measurements and the secondary set of CSI measurements comprises one or more CSI measurements that are not included in the primary set of CSI measurements, as described above.

Process 700 may include additional aspects, such as any single aspect or any combination of aspects described below and/or in connection with one or more other processes described elsewhere herein.

In a first aspect, the reference signal resource set comprises at least one of a CSI-RS resource set, or an SSB resource set. In a second aspect, alone or in combination with the first aspect, the plurality of CSI measurements comprises at least one of an SSB index RSRP, an SSB index SINR, a CRI RSRP, or a CRI SINR. In a third aspect, alone or in combination with one or more of the first and second aspects, the secondary set of CSI measurements corresponds to a set of reference signals associated with the reference signal resource set, and the set of reference signals is indicated by at least one of a wireless communication standard or the configuration. In a fourth aspect, alone or in combination with one or more of the first through third aspects, a quantity of CSI reports of the at least one CSI report is indicated by at least one of a wireless communication standard or the configuration. In a fifth aspect, alone or in combination with one or more of the first through fourth aspects, a quantization of the at least one CSI report is indicated by at least one of a wireless communication standard or the configuration.

In a sixth aspect, alone or in combination with one or more of the first through fifth aspects, the at least one CSI report consists of a single CSI report. In a seventh aspect, alone or in combination with the sixth aspect, process 700 includes receiving, from an additional network node, a capability report that indicates a maximum quantity of reported CSI measurements that the additional network node is capable of reporting in the single CSI report, the maximum quantity of reported CSI measurements comprising a sum of a maximum quantity of CSI measurements of the primary set of CSI measurements and a maximum quantity of CSI measurements of the secondary set of CSI measurements. In an eighth aspect, alone or in combination with one or more of the sixth through seventh aspects, process 700 includes receiving, from an additional network node, a capability report comprising an indication of a maximum quantity of reported CSI measurements that the additional network node is capable of reporting in the single CSI report, wherein the indication indicates a maximum quantity of CSI measurements of the secondary set of CSI measurements. In a ninth aspect, alone or in combination with one or more of the sixth through eighth aspects, the one or more CSI report settings consists of a single CSI report setting corresponding to the single CSI report, the CSI report setting indicating the primary set of CSI measurements and the secondary set of CSI measurements.

In a tenth aspect, alone or in combination with the ninth aspect, the single CSI report setting comprises a configuration of the primary set of CSI measurements and a configuration of the secondary set of CSI measurements. In an eleventh aspect, alone or in combination with the ninth aspect, the single CSI report setting comprises a configuration of the primary set of CSI measurements, and a configuration of a difference between a total set of CSI measurements and the primary set of CSI measurements, wherein the total set of CSI measurements comprises the primary set of CSI measurements and the secondary set of CSI measurements. In a twelfth aspect, alone or in combination with one or more of the sixth through eleventh aspects, receiving the at least one CSI report comprises receiving a first communication comprising a first part of the single CSI report, and receiving a second communication comprising a second part of the single CSI report. In a thirteenth aspect, alone or in combination with the twelfth aspect, the first part of the single CSI report includes the primary set of CSI measurements, and the second part of the single CSI report includes the secondary set of CSI measurements.

In a fourteenth aspect, alone or in combination with one or more of the first through thirteenth aspects, the at least one CSI report comprises a plurality of CSI reports. In a fifteenth aspect, alone or in combination with the fourteenth aspect, the one or more CSI report settings comprises a plurality of CSI report settings corresponding to the plurality of CSI reports. In a sixteenth aspect, alone or in combination with the fifteenth aspect, process 700 includes receiving, from an additional network node, a capability report that indicates a maximum quantity of reported CSI measurements that the additional network node is capable of reporting in the plurality of CSI reports, the maximum quantity of reported CSI measurements comprising a maximum quantity of CSI measurements of the secondary set of CSI measurements, wherein the plurality of CSI report settings are based at least in part on the capability report.

In a seventeenth aspect, alone or in combination with one or more of the fifteenth through sixteenth aspects, the plurality of CSI report settings include a CSI report setting corresponding to the primary set of CSI measurements, and at least one additional CSI report setting corresponding to the secondary set of CSI measurements. In an eighteenth aspect, alone or in combination with the seventeenth aspect, a first periodicity corresponding to a first time period between CSI report transmissions is associated with the CSI report setting, and a second periodicity corresponding to a second time period between CSI transmissions is associated with the at least one additional CSI report setting, wherein the second time period is longer than the first time period. In a nineteenth aspect, alone or in combination with one or more of the seventeenth or eighteenth aspects, the at least one additional CSI report setting comprises a plurality of additional CSI report settings, wherein a total quantity of reference signals in a set of reference signals corresponding to the reference signal resource set, and associated with the plurality of additional CSI report settings, is no greater than a maximum quantity, indicated in a capability report, of CSI measurements of the secondary set of CSI measurements. In a twentieth aspect, alone or in combination with the nineteenth aspect, a first additional CSI report setting of the plurality of additional CSI report settings indicates a first subset of reference signals of the set of reference signals, and a second additional CSI report setting of the plurality of additional CSI report settings indicates a second subset of reference signals of the set of reference signals, wherein the second subset of reference signals is different than the first subset of reference signals. In a twenty-first aspect, alone or in combination with the twentieth aspect, at least one of an association between the first subset of reference signals and the first additional CSI report setting or an association between the second subset of reference signals and the second additional CSI report setting is indicated by at least one of a wireless communication standard or the configuration.

In a twenty-second aspect, alone or in combination with one or more of the fourteenth through twenty-first aspects, at least one CPU is associated with the plurality of CSI reports. In a twenty-third aspect, alone or in combination with the twenty-second aspect, the at least one CPU consists of a single CPU corresponding to the plurality of CSI reports. In a twenty-fourth aspect, alone or in combination with the twenty-third aspect, the single CPU is associated with a CSI report of the plurality of CSI reports, and the CSI report corresponds to the primary set of CSI measurements. In a twenty-fifth aspect, alone or in combination with one or more of the twenty-first through twenty-fourth aspects, process 700 includes receiving a capability report that indicates a maximum quantity of CPUs associated with the plurality of CSI reports.

In a twenty-sixth aspect, alone or in combination with one or more of the first through twenty-fifth aspects, the secondary set of CSI measurements comprises at least one of a strongest RSRP value or a strongest SINR associated with a remaining set of CSI measurements, the remaining set of CSI measurements comprising each CSI measurement of the plurality of CSI measurements that is not included in the primary set of CSI measurements. In a twenty-seventh aspect, alone or in combination with the twenty-sixth aspect, the one or more CSI report settings comprises a first CSI report setting associated with the primary set of CSI measurements, and a second CSI report setting associated with the secondary set of CSI measurements, the first CSI report setting indicating an index corresponding to the second CSI report setting, and the first CSI report setting indicates at least one rule associated with reporting the at least one of the strongest RSRP value or the strongest SINR associated with the remaining set of CSI measurements. In a twenty-eighth aspect, alone or in combination with the twenty-sixth aspect, the one or more CSI report settings comprises a first CSI report setting associated with the primary set of CSI measurements, and a second CSI report setting associated with the secondary set of CSI measurements, the second CSI report setting indicating an index corresponding to the first CSI report setting, and the second CSI report setting indicates at least one rule associated with reporting the at least one of the strongest RSRP value or the strongest SINR associated with the remaining set of CSI measurements. In a twenty-ninth aspect, alone or in combination with the twenty-sixth aspect, the one or more CSI report settings comprises a first CSI report setting and a second CSI report setting, and the configuration indicates an index corresponding to the first CSI report setting, an index corresponding to the second CSI report setting, and at least one rule associated with reporting the at least one of the strongest RSRP value or the strongest SINR associated with the remaining set of CSI measurements.

In a thirtieth aspect, alone or in combination with one or more of the twenty-seventh through twenty-ninth aspects, the one or more CSI report settings comprises a CSI report setting associated with the primary set of CSI measurements, and at least one additional CSI report setting associated with the at least one of the strongest RSRP value or the strongest SINR associated with the remaining set of CSI measurements. In a thirty-first aspect, alone or in combination with the thirtieth aspect, the at least one additional CSI report setting comprises a first additional CSI report setting associated with a first subset of the at least one of the strongest RSRP value or the strongest SINR associated with the remaining set of CSI measurements, wherein the first subset of the at least one of the strongest RSRP value or the strongest SINR associated with the remaining set of CSI measurements comprises at least one of a strongest RSRP value or a strongest SINR associated with at least one of a strongest RSRP value or a strongest SINR associated with the remaining set of CSI measurements, and a second additional CSI report setting associated with a second subset of the at least one of the strongest RSRP value or the strongest SINR associated with the remaining set of CSI measurements, wherein the second subset of the at least one of the strongest RSRP value or the strongest SINR associated with the remaining set of CSI measurements comprises at least one of a strongest RSRP value or a strongest SINR associated with an additional remaining set of CSI measurements, the additional remaining set of CSI measurements comprising each CSI measurement of the at least one of the strongest RSRP value or the strongest SINR that is not included in the first subset of the at least one of the strongest RSRP value or the strongest SINR associated with the remaining set of CSI measurements.

In a thirty-second aspect, alone or in combination with the thirty-first aspect, the CSI report setting indicates an index corresponding to the at least one additional CSI report setting, and at least one rule associated with reporting the at least one of the strongest RSRP value or the strongest SINR associated with the remaining set of CSI measurements. In a thirty-third aspect, alone or in combination with the thirty-first aspect, the first additional CSI report setting indicates an index corresponding to the CSI report setting, an index corresponding to the second additional CSI report setting, and at least one rule associated with reporting the at least one of the strongest RSRP value or the strongest SINR associated with the remaining set of CSI measurements. In a thirty-fourth aspect, alone or in combination with the thirty-first aspect, the configuration indicates a first index corresponding to the CSI report setting, a second index corresponding to the first additional CSI report setting, a third index corresponding to the second additional CSI report setting, and an order of the first index, the second index, and the third index based at least in part on a first CSI measurement strength level associated with the CSI report setting, a second CSI measurement strength level associated with the first additional CSI report setting, and a third CSI measurement strength level associated with the second additional CSI report setting.

In a thirty-fifth aspect, alone or in combination with the thirtieth aspect, a first priority associated with a first CSI report setting of the CSI report setting and the at least one additional CSI report setting is higher than a second priority associated with a second CSI report setting of the CSI report setting and the at least one additional CSI report setting based at least in part on at least one CSI measurement strength associated with the first CSI report being greater than at least one additional CSI measurement strength associated with the second CSI report. In a thirty-sixth aspect, alone or in combination with the thirtieth aspect, a first priority associated with at least one CSI measurement of a single CSI report setting of the CSI report setting and the at least one additional CSI report setting is higher than a second priority associated with at least one additional CSI measurement of the single CSI report setting based at least in part on at least one measurement strength associated with the at least one CSI measurement being greater than at least one additional measurement strength associated with the at least one additional CSI measurement.

In a thirty-seventh aspect, alone or in combination with one or more of the first through thirty-sixth aspects, a CSI measurement of the secondary set of CSI measurements is adjacent to a CSI measurement of the primary set of CSI measurements. In a thirty-eighth aspect, alone or in combination with the thirty-seventh aspect, a first reference signal ID corresponds to the CSI measurement of the secondary set of CSI measurements and a second reference signal ID corresponds to the CSI measurement of the primary set of CSI measurements, and the CSI measurement of the secondary set of CSI measurements is adjacent to the CSI measurement of the primary set of CSI measurements based at least in part on the first reference signal ID being adjacent to the second reference signal ID. In a thirty-ninth aspect, alone or in combination with one or more of the thirty-seventh or thirty-eighth aspects, the CSI measurement of the secondary set of CSI measurements is adjacent to the CSI measurement of the primary set of CSI measurements based at least in part on a minimum angular separation between a beam corresponding to the CSI measurement of the primary set of CSI measurements and a beam corresponding to the CSI measurement of the secondary set of CSI measurements.

In a fortieth aspect, alone or in combination with one or more of the first through thirty-ninth aspects, a quantity of CSI measurements of the primary set of CSI measurements is equal to a quantity of adjacent CSI measurements of the secondary set of CSI measurements. In a forty-first aspect, alone or in combination with one or more of the first through fortieth aspects, a quantity of CSI measurements of the primary set of CSI measurements is not equal to a quantity of adjacent CSI measurements of the secondary set of CSI measurements. In a forty-second aspect, alone or in combination with the forty-first aspect, a ratio of the quantity of adjacent CSI measurements of the secondary set of CSI measurements to the quantity of CSI measurements of the primary set of CSI measurements is indicated by at least one of a wireless communication standard or the configuration.

In a forty-third aspect, alone or in combination with one or more of the forty-first or forty-second aspects, the primary set of CSI measurements comprises a first subset of CSI measurements, wherein the first subset of CSI measurements comprises at least one of a strongest RSRP value or a strongest SINR associated with the primary set of CSI measurements, and a second subset of CSI measurements, wherein the second subset of CSI measurements comprises at least one of a strongest RSRP value or a strongest SINR associated with a remaining subset of CSI measurements of the primary set of CSI measurements, the remaining subset of CSI measurements comprising each CSI measurement of the primary set of CSI measurements that is not included in the first subset of CSI measurements. In a forty-fourth aspect, alone or in combination with the forty-third aspect, the configuration indicates a first quantity of adjacent CSI measurements, of the secondary set of CSI measurements, associated with the first subset of CSI measurements, and a second quantity of adjacent CSI measurements, of the secondary set of CSI measurements, associated with the second subset of CSI measurements.

In a forty-fifth aspect, alone or in combination with one or more of the first through forty-fourth aspects, the secondary set of CSI measurements comprises at least one adjacent CSI measurement of a plurality of adjacent CSI measurements, wherein at least one reference signal ID corresponding to the at least one adjacent CSI measurement satisfies a reference signal ID condition. In a forty-sixth aspect, alone or in combination with the forty-fifth aspect, the at least one reference signal ID satisfies the reference signal ID condition based at least in part on the at least one reference signal ID having a value that is less than at least one additional value of at least one additional reference signal ID corresponding to at least one additional adjacent CSI measurement of the plurality of adjacent CSI measurements. In a forty-seventh aspect, alone or in combination with the forty-fifth aspect, the at least one reference signal ID satisfies the reference signal ID condition based at least in part on the at least one reference signal ID having a value that is less than at least one additional value of at least one additional reference signal ID corresponding to at least one additional adjacent CSI measurement of the plurality of adjacent CSI measurements. In a forty-eighth aspect, alone or in combination with one or more of the forty-fifth through forty-seventh aspects, the at least one CSI report indicates a set of reference signal IDs corresponding to the primary set of CSI measurements, and the at least one CSI report does not indicate a reference signal ID corresponding to the at least one adjacent CSI measurement.

In a forty-ninth aspect, alone or in combination with the forty-eighth aspect, the at least one adjacent CSI measurement comprises a first adjacent CSI measurement, wherein a value of a first reference signal ID corresponding to the first adjacent CSI measurement is one greater than a value of a second reference signal ID corresponding to a CSI measurement of the primary set of CSI measurements, and a second adjacent CSI measurement, wherein a value of a third reference signal ID corresponding to the second adjacent CSI measurement is one less than a value of the second reference signal ID. In a fiftieth aspect, alone or in combination with the forty-eighth aspect, the at least one CSI report comprises a first indication of an adjacent CSI measurement of the at least one adjacent CSI measurement, wherein a value of a first reference signal ID corresponding to the adjacent CSI measurement is one greater than a value of a second reference signal ID corresponding to a CSI measurement of the primary set of CSI measurements or one less than the value of a second reference signal ID corresponding to a CSI measurement of the primary set of CSI measurements, and a second indication of the adjacent CSI measurement. In a fifty-first aspect, alone or in combination with the forty-eighth aspect, the at least one CSI report comprises only one indication of an adjacent CSI measurement of the at least one adjacent CSI measurement, wherein a value of a first reference signal ID corresponding to the adjacent CSI measurement is one greater than a value of a second reference signal ID corresponding to a CSI measurement of the primary set of CSI measurements or one less than the value of a second reference signal ID corresponding to a CSI measurement of the primary set of CSI measurements. In a fifty-second aspect, alone or in combination with the fifty-first aspect, the at least one CSI report comprises the only one indication of the adjacent CSI measurement based at least in part on a payload size associated with the at least one CSI report.

In a fifty-third aspect, alone or in combination with one or more of the first through fifty-second aspects, the at least one CSI report is quantized based at least in part on a quantization method associated with the primary set of CSI measurements, and at least one additional quantization method associated with the secondary set of CSI measurements. In a fifty-fourth aspect, alone or in combination with the fifty-third aspect, the at least one additional quantization method corresponds to a differential report of a CSI measurement of the secondary set of CSI measurements based at least in part on a relative CSI measurement strength associated with a CSI measurement of the primary set of CSI measurements. In a fifty-fifth aspect, alone or in combination with the fifty-third aspect, the at least one additional quantization method corresponds to a differential report of at least one CSI measurement of a first subset of the secondary set of CSI measurements relative to at least one CSI measurement of the primary set of CSI measurements, and a differential report of at least one CSI measurement of a second subset of the secondary set of CSI measurements relative to the at least one CSI measurement of the first subset. In a fifty-sixth aspect, alone or in combination with the fifty-fifth aspect, the differential report of the at least one CSI measurement of the second subset comprises a differential report of the at least one CSI measurement of the second subset based at least in part on a relative CSI measurement strength associated with the at least one CSI measurement of the first subset. In a fifty-seventh aspect, alone or in combination with the fifty-third aspect, the at least one additional quantization method associated with the secondary set of CSI measurements corresponds to a differential report of a CSI measurement of the secondary set of CSI measurements relative to an adjacent CSI measurement of the primary set of CSI measurements.

In a fifty-eighth aspect, alone or in combination with one or more of the first through fifty-sixth aspects, the at least one CSI report is quantized based at least in part on a quantization method associated with the primary set of CSI measurements based at least in part on a quantization parameter value, and at least one additional quantization method associated with the secondary set of CSI measurements based at least in part on at least one additional quantization parameter value, wherein the at least one additional quantization parameter value is different than the quantization parameter value. In a fifty-ninth aspect, alone or in combination with the fifty-eighth aspect, the quantization parameter value indicates at least one of a quantization step size or a dynamic range.

Although FIG. 7 shows example blocks of process 700, in some aspects, process 700 may include additional blocks, fewer blocks, different blocks, or differently arranged blocks than those depicted in FIG. 7. Additionally, or alternatively, two or more of the blocks of process 700 may be performed in parallel.

FIG. 8 is a diagram of an example apparatus 800 for wireless communication. The apparatus 800 may be a network node, or a network node may include the apparatus 800. In some aspects, the apparatus 800 includes a reception component 802 and a transmission component 804, which may be in communication with one another (for example, via one or more buses and/or one or more other components). As shown, the apparatus 800 may communicate with another apparatus 806 (such as a UE, a base station, or another wireless communication device) using the reception component 802 and the transmission component 804. As further shown, the apparatus 800 may include the communication manager 808. The communication manager 808 may include one or more of a determination component 810, or an identification component 812, among other examples.

In some aspects, the apparatus 800 may be configured to perform one or more operations described herein in connection with FIG. 5. Additionally, or alternatively, the apparatus 800 may be configured to perform one or more processes described herein, such as process 600 of FIG. 6, process 700 of FIG. 7, or a combination thereof. In some aspects, the apparatus 800 and/or one or more components shown in FIG. 8 may include one or more components of the UE and/or the base station described in connection with FIG. 2. Additionally, or alternatively, one or more components shown in FIG. 8 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 802 may receive communications, such as reference signals, control information, data communications, or a combination thereof, from the apparatus 806. The reception component 802 may provide received communications to one or more other components of the apparatus 800. In some aspects, the reception component 802 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 800. In some aspects, the reception component 802 may include one or more antennas, a modem, a demodulator, a MIMO detector, a receive processor, a controller/processor, a memory, or a combination thereof, of the UE and/or the base station described in connection with FIG. 2.

The transmission component 804 may transmit communications, such as reference signals, control information, data communications, or a combination thereof, to the apparatus 806. In some aspects, one or more other components of the apparatus 800 may generate communications and may provide the generated communications to the transmission component 804 for transmission to the apparatus 806. In some aspects, the transmission component 804 may perform signal processing on the generated communications (such as filtering, amplification, modulation, digital-to-analog conversion, multiplexing, interleaving, mapping, or encoding, among other examples), and may transmit the processed signals to the apparatus 806. In some aspects, the transmission component 804 may include one or more antennas, a modem, a modulator, a transmit MIMO processor, a transmit processor, a controller/processor, a memory, or a combination thereof, of the UE and/or the base station described in connection with FIG. 2. In some aspects, the transmission component 804 may be co-located with the reception component 802 in a transceiver.

The reception component 802 may receive a configuration corresponding to one or more CSI report settings associated with a reference signal resource set. The transmission component 804 may transmit, based at least in part on the configuration, at least one CSI report that indicates a primary set of CSI measurements, of a plurality of CSI measurements associated with the reference signal resource set, and a secondary set of CSI measurements of the plurality of CSI measurements, wherein the primary set of CSI measurements comprises at least one of a strongest RSRP value or a strongest SINR associated with the plurality of CSI measurements and the secondary set of CSI measurements comprises one or more CSI measurements that are not included in the primary set of CSI measurements.

The transmission component 804 may transmit a capability report that indicates a maximum quantity of reported CSI measurements that the network node is capable of reporting in the single CSI report, the maximum quantity of reported CSI measurements comprising a sum of a maximum quantity of CSI measurements of the primary set of CSI measurements and a maximum quantity of CSI measurements of the secondary set of CSI measurements. The transmission component 804 may transmit a capability report comprising an indication of a maximum quantity of reported CSI measurements that the network node is capable of reporting in the single CSI report, wherein the indication indicates a maximum quantity of CSI measurements of the secondary set of CSI measurements. The transmission component 804 may transmit a capability report that indicates a maximum quantity of reported CSI measurements that the network node is capable of reporting in the plurality of CSI reports, the maximum quantity of reported CSI measurements comprising a maximum quantity of CSI measurements of the secondary set of CSI measurements, wherein the plurality of CSI report settings are based at least in part on the capability report.

The communication manager 808 and/or the determination component 810 may determine at least one CPU associated with the plurality of CSI reports. In some aspects, the communication manager 808 may include one or more antennas, a modem, a controller/processor, a memory, or a combination thereof, of the UE and/or the base station described in connection with FIG. 2. In some aspects, the communication manager 808 may include the reception component 802 and/or the transmission component 804. In some aspects, the determination component 810 may include one or more antennas, a modem, a controller/processor, a memory, or a combination thereof, of the UE and/or the base station described in connection with FIG. 2. In some aspects, the determination component 810 may include the reception component 802 and/or the transmission component 804.

The communication manager 808 may associate the single CPU with a CSI report of the plurality of CSI reports, wherein the CSI report corresponds to the primary set of CSI measurements. The transmission component 804 may transmit a capability report that indicates a maximum quantity of CPUs associated with the plurality of CSI reports. The communication manager 808 and/or the transmission component 804 may drop a CSI report corresponding to the second CSI report setting based at least in part on the first priority being higher than the second priority. The communication manager 808 and/or the transmission component 804 may omit, from a single CSI report corresponding to the single CSI report setting, the at least one additional CSI measurement based at least in part on the first priority being higher than the second priority.

The communication manager 808 and/or the identification component 812 may identify a plurality of adjacent CSI measurements of the plurality of CSI measurements. In some aspects, the identification component 812 may include one or more antennas, a modem, a controller/processor, a memory, or a combination thereof, of the UE and/or the base station described in connection with FIG. 2. In some aspects, the identification component 812 may include the reception component 802 and/or the transmission component 804.

The determination component 810 may determine that a quantity of adjacent CSI measurements of the plurality of adjacent CSI measurements satisfies a measurement quantity threshold. The determination component 810 may determine, based at least in part on determining that the quantity of adjacent CSI measurements satisfies the measurement threshold, that at least one reference signal ID corresponding to at least one adjacent CSI measurement, of the plurality of adjacent CSI measurements, satisfies a reference signal ID condition, wherein the secondary set of CSI measurements comprises the at least one adjacent CSI measurement based at least in part on determining that the at least one reference signal ID satisfies the reference signal ID condition.

The transmission component 804 may transmit a configuration corresponding to one or more CSI report settings associated with a reference signal resource set. The reception component 802 may receive, based at least in part on the configuration, at least one CSI report that indicates a primary set of CSI measurements, of a plurality of CSI measurements associated with the reference signal resource set, and a secondary set of CSI measurements of the plurality of CSI measurements, wherein the primary set of CSI measurements comprises at least one of a strongest RSRP value or a strongest SINR associated with the plurality of CSI measurements and the secondary set of CSI measurements comprises one or more CSI measurements that are not included in the primary set of CSI measurements.

The reception component 802 may receive, from an additional network node, a capability report that indicates a maximum quantity of reported CSI measurements that the additional network node is capable of reporting in the single CSI report, the maximum quantity of reported CSI measurements comprising a sum of a maximum quantity of CSI measurements of the primary set of CSI measurements and a maximum quantity of CSI measurements of the secondary set of CSI measurements. The reception component 802 may receive, from an additional network node, a capability report comprising an indication of a maximum quantity of reported CSI measurements that the additional network node is capable of reporting in the single CSI report, wherein the indication indicates a maximum quantity of CSI measurements of the secondary set of CSI measurements.

The reception component 802 may receive, from an additional network node, a capability report that indicates a maximum quantity of reported CSI measurements that the additional network node is capable of reporting in the plurality of CSI reports, the maximum quantity of reported CSI measurements comprising a maximum quantity of CSI measurements of the secondary set of CSI measurements, wherein the plurality of CSI report settings are based at least in part on the capability report. The reception component 802 may receive a capability report that indicates a maximum quantity of CPUs associated with the plurality of CSI reports.

The number and arrangement of components shown in FIG. 8 are provided as an example. In practice, there may be additional components, fewer components, different components, or differently arranged components than those shown in FIG. 8.

Furthermore, two or more components shown in FIG. 8 may be implemented within a single component, or a single component shown in FIG. 8 may be implemented as multiple, distributed components. Additionally, or alternatively, a set of (one or more) components shown in FIG. 8 may perform one or more functions described as being performed by another set of components shown in FIG. 8.

The following provides an overview of some Aspects of the present disclosure:

Aspect 1: A method of wireless communication performed by a network node, comprising: receiving a configuration corresponding to one or more channel state information (CSI) report settings associated with a reference signal resource set; and transmitting, based at least in part on the configuration, at least one CSI report that indicates a primary set of CSI measurements, of a plurality of CSI measurements associated with the reference signal resource set, and a secondary set of CSI measurements of the plurality of CSI measurements, wherein the plurality of CSI measurements comprises at least one of a physical layer reference signal received power (RSRP) value or a physical layer signal-to-interference-plus-noise ratio (SINR), and wherein the primary set of CSI measurements comprises at least one of a strongest RSRP value or a strongest SINR associated with the plurality of CSI measurements and the secondary set of CSI measurements comprises one or more CSI measurements that are not included in the primary set of CSI measurements.

Aspect 2: The method of Aspect 1, wherein the reference signal resource set comprises at least one of: a CSI reference signal (CSI-RS) set, or a synchronization signal block (SSB) resource set.

Aspect 3: The method of Aspect 2, wherein the plurality of CSI measurements comprises at least one of: an SSB index RSRP, an SSB index SINR, a CSI-RS resource indicator (CRI) RSRP, or a CRI SINR.

Aspect 4: The method of any of Aspects 1-3, wherein the secondary set of CSI measurements corresponds to a set of reference signals associated with the reference signal resource set, and wherein the set of reference signals is indicated by at least one of a wireless communication standard or the configuration.

Aspect 5: The method of any of Aspects 1-4, wherein a quantity of CSI reports of the at least one CSI report is indicated by at least one of a wireless communication standard or the configuration.

Aspect 6: The method of any of Aspects 1-5, wherein a quantization of the at least one CSI report is indicated by at least one of a wireless communication standard or the configuration.

Aspect 7: The method of any of Aspects 1-6, wherein the at least one CSI report consists of a single CSI report.

Aspect 8: The method of Aspect 7, further comprising transmitting a capability report that indicates a maximum quantity of reported CSI measurements that the network node is capable of reporting in the single CSI report, the maximum quantity of reported CSI measurements comprising a sum of a maximum quantity of CSI measurements of the primary set of CSI measurements and a maximum quantity of CSI measurements of the secondary set of CSI measurements.

Aspect 9: The method of either of Aspects 7 or 8, further comprising transmitting a capability report comprising an indication of a maximum quantity of reported CSI measurements that the network node is capable of reporting in the single CSI report, wherein the indication indicates a maximum quantity of CSI measurements of the secondary set of CSI measurements.

Aspect 10: The method of any of Aspects 7-9, wherein the one or more CSI report settings consists of a single CSI report setting corresponding to the single CSI report, the CSI report setting indicating the primary set of CSI measurements and the secondary set of CSI measurements.

Aspect 11: The method of Aspect 10, wherein the single CSI report setting comprises a configuration of the primary set of CSI measurements and a configuration of the secondary set of CSI measurements.

Aspect 12: The method of Aspect 10, wherein the single CSI report setting comprises: a configuration of the primary set of CSI measurements; and a configuration of a difference between a total set of CSI measurements and the primary set of CSI measurements, wherein the total set of CSI measurements comprises the primary set of CSI measurements and the secondary set of CSI measurements.

Aspect 13: The method of any of Aspects 7-12, wherein transmitting the at least one CSI report comprises: transmitting a first communication comprising a first part of the single CSI report; and transmitting a second communication comprising a second part of the single CSI report.

Aspect 14: The method of Aspect 13, wherein the first part of the single CSI report includes the primary set of CSI measurements, and wherein the second part of the single CSI report includes the secondary set of CSI measurements.

Aspect 15: The method of any of Aspects 1-6, wherein the at least one CSI report comprises a plurality of CSI reports.

Aspect 16: The method of Aspect 15, wherein the one or more CSI report settings comprises a plurality of CSI report settings corresponding to the plurality of CSI reports.

Aspect 17: The method of Aspect 16, further comprising transmitting a capability report that indicates a maximum quantity of reported CSI measurements that the network node is capable of reporting in the plurality of CSI reports, the maximum quantity of reported CSI measurements comprising a maximum quantity of CSI measurements of the secondary set of CSI measurements, wherein the plurality of CSI report settings are based at least in part on the capability report.

Aspect 18: The method of either of Aspects 16 or 17, wherein the plurality of CSI report settings include: a CSI report setting corresponding to the primary set of CSI measurements; and at least one additional CSI report setting corresponding to the secondary set of CSI measurements.

Aspect 19: The method of Aspect 18, wherein a first periodicity corresponding to a first time period between CSI report transmissions is associated with the CSI report setting, and a second periodicity corresponding to a second time period between CSI transmissions is associated with the at least one additional CSI report setting, wherein the second time period is longer than the first time period.

Aspect 20: The method of either of Aspects 18 or 19, wherein the at least one additional CSI report setting comprises a plurality of additional CSI report settings, wherein a total quantity of reference signals in a set of reference signals corresponding to the reference signal resource set, and associated with the plurality of additional CSI report settings, is no greater than a maximum quantity, indicated in a capability report, of CSI measurements of the secondary set of CSI measurements.

Aspect 21: The method of Aspect 20, wherein a first additional CSI report setting of the plurality of additional CSI report settings indicates a first subset of reference signals of the set of reference signals, and wherein a second additional CSI report setting of the plurality of additional CSI report settings indicates a second subset of reference signals of the set of reference signals, wherein the second subset of reference signals is different than the first subset of reference signals.

Aspect 22: The method of Aspect 21, wherein at least one of an association between the first subset of reference signals and the first additional CSI report setting or an association between the second subset of reference signals and the second additional CSI report setting is indicated by at least one of a wireless communication standard or the configuration.

Aspect 23: The method of any of Aspects 15-22, further comprising determining at least one CSI processing unit (CPU) associated with the plurality of CSI reports.

Aspect 24: The method of Aspect 23, wherein the at least one CPU consists of a single CPU corresponding to the plurality of CSI reports.

Aspect 25: The method of Aspect 24, further comprising associating the single CPU with a CSI report of the plurality of CSI reports, wherein the CSI report corresponds to the primary set of CSI measurements.

Aspect 26: The method of any of Aspects 15-25, further comprising transmitting a capability report that indicates a maximum quantity of CPUs associated with the plurality of CSI reports.

Aspect 27: The method of any of Aspects 1-26, wherein the secondary set of CSI measurements comprises at least one of a strongest RSRP value or a strongest SINR associated with a remaining set of CSI measurements, the remaining set of CSI measurements comprising each CSI measurement of the plurality of CSI measurements that is not included in the primary set of CSI measurements.

Aspect 28: The method of Aspect 27, wherein the one or more CSI report settings comprises: a first CSI report setting associated with the primary set of CSI measurements; and a second CSI report setting associated with the secondary set of CSI measurements, the first CSI report setting indicating an index corresponding to the second CSI report setting, and wherein the first CSI report setting indicates at least one rule associated with reporting the at least one of the strongest RSRP value or the strongest SINR associated with the remaining set of CSI measurements.

Aspect 29: The method of Aspect 27, wherein the one or more CSI report settings comprises: a first CSI report setting associated with the primary set of CSI measurements; and a second CSI report setting associated with the secondary set of CSI measurements, the second CSI report setting indicating an index corresponding to the first CSI report setting, and wherein the second CSI report setting indicates at least one rule associated with reporting the at least one of the strongest RSRP value or the strongest SINR associated with the remaining set of CSI measurements.

Aspect 30: The method of Aspect 27, wherein the one or more CSI report settings comprises a first CSI report setting and a second CSI report setting, and wherein the configuration indicates: an index corresponding to the first CSI report setting, an index corresponding to the second CSI report setting, and at least one rule associated with reporting the at least one of the strongest RSRP value or the strongest SINR associated with the remaining set of CSI measurements.

Aspect 31: The method of any of Aspects 27-30, wherein the one or more CSI report settings comprises: a CSI report setting associated with the primary set of CSI measurements; and at least one additional CSI report setting associated with the at least one of the strongest RSRP value or the strongest SINR associated with the remaining set of CSI measurements.

Aspect 32: The method of Aspect 31, wherein the at least one additional CSI report setting comprises: a first additional CSI report setting associated with a first subset of the at least one of the strongest RSRP value or the strongest SINR associated with the remaining set of CSI measurements, wherein the first subset of the at least one of the strongest RSRP value or the strongest SINR associated with the remaining set of CSI measurements comprises at least one of a strongest RSRP value or a strongest SINR associated with at least one of a strongest RSRP value or a strongest SINR associated with the remaining set of CSI measurements; and a second additional CSI report setting associated with a second subset of the at least one of the strongest RSRP value or the strongest SINR associated with the remaining set of CSI measurements, wherein the second subset of the at least one of the strongest RSRP value or the strongest SINR associated with the remaining set of CSI measurements comprises at least one of a strongest RSRP value or a strongest SINR associated with an additional remaining set of CSI measurements, the additional remaining set of CSI measurements comprising each CSI measurement of the at least one of the strongest RSRP value or the strongest SINR that is not included in the first subset of the at least one of the strongest RSRP value or the strongest SINR associated with the remaining set of CSI measurements.

Aspect 33: The method of Aspect 32, wherein the CSI report setting indicates: an index corresponding to the at least one additional CSI report setting, and at least one rule associated with reporting the at least one of the strongest RSRP value or the strongest SINR associated with the remaining set of CSI measurements.

Aspect 34: The method of Aspect 32, wherein the first additional CSI report setting indicates: an index corresponding to the CSI report setting, an index corresponding to the second additional CSI report setting, and at least one rule associated with reporting the at least one of the strongest RSRP value or the strongest SINR associated with the remaining set of CSI measurements.

Aspect 35: The method of Aspect 32, wherein the configuration indicates: a first index corresponding to the CSI report setting, a second index corresponding to the first additional CSI report setting, a third index corresponding to the second additional CSI report setting, and an order of the first index, the second index, and the third index based at least in part on a first CSI measurement strength level associated with the CSI report setting, a second CSI measurement strength level associated with the first additional CSI report setting, and a third CSI measurement strength level associated with the second additional CSI report setting.

Aspect 36: The method of Aspect 31, wherein a first priority associated with a first CSI report setting of the CSI report setting and the at least one additional CSI report setting is higher than a second priority associated with a second CSI report setting of the CSI report setting and the at least one additional CSI report setting based at least in part on at least one CSI measurement strength associated with the first CSI report being greater than at least one additional CSI measurement strength associated with the second CSI report.

Aspect 37: The method of Aspect 36, further comprising dropping a CSI report corresponding to the second CSI report setting based at least in part on the first priority being higher than the second priority.

Aspect 38: The method of any of Aspects 31-37, wherein a first priority associated with at least one CSI measurement of a single CSI report setting of the CSI report setting and the at least one additional CSI report setting is higher than a second priority associated with at least one additional CSI measurement of the single CSI report setting based at least in part on at least one measurement strength associated with the at least one CSI measurement being greater than at least one additional measurement strength associated with the at least one additional CSI measurement.

Aspect 39: The method of Aspect 38, further comprising omitting, from a single CSI report corresponding to the single CSI report setting, the at least one additional CSI measurement based at least in part on the first priority being higher than the second priority.

Aspect 40: The method of any of Aspects 1-39, wherein a CSI measurement of the secondary set of CSI measurements is adjacent to a CSI measurement of the primary set of CSI measurements.

Aspect 41: The method of Aspect 40, wherein a first reference signal identifier (ID) corresponds to the CSI measurement of the secondary set of CSI measurements and a second reference signal ID corresponds to the CSI measurement of the primary set of CSI measurements, and wherein the CSI measurement of the secondary set of CSI measurements is adjacent to the CSI measurement of the primary set of CSI measurements based at least in part on the first reference signal ID being adjacent to the second reference signal ID.

Aspect 42: The method of either of Aspects 40 or 41, wherein the CSI measurement of the secondary set of CSI measurements is adjacent to the CSI measurement of the primary set of CSI measurements based at least in part on a minimum angular separation between a beam corresponding to the CSI measurement of the primary set of CSI measurements and a beam corresponding to the CSI measurement of the secondary set of CSI measurements.

Aspect 43: The method of any of Aspects 1-42, wherein a quantity of CSI measurements of the primary set of CSI measurements is equal to a quantity of adjacent CSI measurements of the secondary set of CSI measurements.

Aspect 44: The method of any of Aspects 1-42, wherein a quantity of CSI measurements of the primary set of CSI measurements is not equal to a quantity of adjacent CSI measurements of the secondary set of CSI measurements.

Aspect 45: The method of Aspect 44, wherein a ratio of a quantity of adjacent CSI measurements of the secondary set of CSI measurements to a quantity of CSI measurements of the primary set of CSI measurements is indicated by at least one of a wireless communication standard or the configuration.

Aspect 46: The method of either of Aspects 44 or 45, wherein the primary set of CSI measurements comprises: a first subset of CSI measurements, wherein the first subset of CSI measurements comprises at least one of a strongest RSRP value or a strongest SINR associated with the primary set of CSI measurements; and a second subset of CSI measurements, wherein the second subset of CSI measurements comprises at least one of a strongest RSRP value or a strongest SINR associated with a remaining subset of CSI measurements of the primary set of CSI measurements, the remaining subset of CSI measurements comprising each CSI measurement of the primary set of CSI measurements that is not included in the first subset of CSI measurements.

Aspect 47: The method of Aspect 46, wherein the configuration indicates: a first quantity of adjacent CSI measurements, of the secondary set of CSI measurements, associated with the first subset of CSI measurements; and a second quantity of adjacent CSI measurements, of the secondary set of CSI measurements, associated with the second subset of CSI measurements.

Aspect 48: The method of any of Aspects 1-47, further comprising: identifying a plurality of adjacent CSI measurements of the plurality of CSI measurements; determining that a quantity of adjacent CSI measurements of the plurality of adjacent CSI measurements satisfies a measurement quantity threshold; and determining, based at least in part on determining that the quantity of adjacent CSI measurements satisfies the measurement threshold, that at least one reference signal identifier (ID) corresponding to at least one adjacent CSI measurement, of the plurality of adjacent CSI measurements, satisfies a reference signal ID condition, wherein the secondary set of CSI measurements comprises the at least one adjacent CSI measurement based at least in part on determining that the at least one reference signal ID satisfies the reference signal ID condition.

Aspect 49: The method of Aspect 48, wherein determining that the at least one reference signal ID satisfies the reference signal ID condition comprises determining that the at least one reference signal ID has a value that is less than at least one additional value of at least one additional reference signal ID corresponding to at least one additional adjacent CSI measurement of the plurality of adjacent CSI measurements.

Aspect 50: The method of Aspect 48, wherein determining that the at least one reference signal ID satisfies the reference signal ID condition comprises determining that the at least one reference signal ID has a value that is greater than at least one additional value of at least one additional reference signal ID corresponding to at least one additional adjacent CSI measurement of the plurality of adjacent CSI measurements.

Aspect 51: The method of any of Aspects 48-50, wherein the at least one CSI report indicates a set of reference signal identifiers (IDs) corresponding to the primary set of CSI measurements.

Aspect 52: The method of Aspect 51, wherein the at least one CSI report does not indicate a reference signal ID corresponding to the at least one adjacent CSI measurement.

Aspect 53: The method of Aspect 52, wherein the at least one adjacent CSI measurement comprises: a first adjacent CSI measurement, wherein a value of a first reference signal ID corresponding to the first adjacent CSI measurement is one greater than a value of a second reference signal ID corresponding to a CSI measurement of the primary set of CSI measurements; and a second adjacent CSI measurement, wherein a value of a third reference signal ID corresponding to the second adjacent CSI measurement is one less than a value of the second reference signal ID.

Aspect 54: The method of Aspect 52, wherein the at least one CSI report comprises: a first indication of an adjacent CSI measurement of the at least one CSI measurement, wherein a value of a first reference signal ID corresponding to the adjacent CSI measurement is one greater than a value of a second reference signal ID corresponding to a CSI measurement of the primary set of CSI measurements or one less than the value of a second reference signal ID corresponding to a CSI measurement of the primary set of CSI measurements; and a second indication of the adjacent CSI measurement.

Aspect 55: The method of Aspect 52, wherein the at least one CSI report comprises only one indication of an adjacent CSI measurement of the at least one CSI measurement, wherein a value of a first reference signal ID corresponding to the adjacent CSI measurement is one greater than a value of a second reference signal ID corresponding to a CSI measurement of the primary set of CSI measurements or one less than the value of a second reference signal ID corresponding to a CSI measurement of the primary set of CSI measurements.

Aspect 56: The method of Aspect 55, wherein the at least one CSI report comprises the only one indication of the adjacent CSI measurement based at least in part on a payload size associated with the at least one CSI report.

Aspect 57: The method of any of Aspects 1-56, wherein transmitting the at least one CSI report comprises: performing a quantization method associated with the primary set of CSI measurements; and performing at least one additional quantization method associated with the secondary set of CSI measurements.

Aspect 58: The method of Aspect 57, wherein performing the at least one additional quantization method comprises differentially reporting a CSI measurement of the secondary set of CSI measurements based at least in part on a relative CSI measurement strength associated with a CSI measurement of the primary set of CSI measurements.

Aspect 59: The method of Aspect 57, wherein performing the at least one additional quantization method comprises: differentially reporting at least one CSI measurement of a first subset of the secondary set of CSI measurements relative to at least one CSI measurement of the primary set of CSI measurements; and differentially reporting at least one CSI measurement of a second subset of the secondary set of CSI measurements relative to the at least one CSI measurement of the first subset.

Aspect 60: The method of Aspect 59, wherein differentially reporting the at least one CSI measurement of the second subset comprises differentially reporting the at least one CSI measurement of the second subset based at least in part on a relative CSI measurement strength associated with the at least one CSI measurement of the first subset.

Aspect 61: The method of Aspect 57, wherein performing at least one additional quantization method associated with the secondary set of CSI measurements comprises differentially reporting a CSI measurement of the secondary set of CSI measurements relative to an adjacent CSI measurement of the primary set of CSI measurements.

Aspect 62: The method of any of Aspects 1-56, wherein transmitting the at least one CSI report comprises: performing a quantization method associated with the primary set of CSI measurements based at least in part on a quantization parameter value; and performing at least one additional quantization method associated with the secondary set of CSI measurements based at least in part on at least one additional quantization parameter value, wherein the at least one additional quantization parameter value is different than the quantization parameter value.

Aspect 63: The method of Aspect 62, wherein the quantization parameter value indicates at least one of a quantization step size or a dynamic range.

Aspect 64: A method of wireless communication performed by a network node, comprising: transmitting a configuration corresponding to one or more channel state information (CSI) report settings associated with a reference signal resource set; and receiving, based at least in part on the configuration, at least one CSI report that indicates a primary set of CSI measurements, of a plurality of CSI measurements associated with the reference signal resource set, and a secondary set of CSI measurements of the plurality of CSI measurements, wherein the plurality of CSI measurements comprises at least one of a physical layer reference signal received power (RSRP) value or a physical layer signal-to-interference-plus-noise ratio (SINR), and wherein the primary set of CSI measurements comprises at least one of a strongest RSRP value or a strongest SINR associated with the plurality of CSI measurements and the secondary set of CSI measurements comprises one or more CSI measurements that are not included in the primary set of CSI measurements.

Aspect 65: The method of Aspect 64, wherein the reference signal resource set comprises at least one of: a CSI reference signal (CSI-RS) set, or a synchronization signal block (SSB) resource set.

Aspect 66: The method of Aspect 65, wherein the plurality of CSI measurements comprises at least one of: an SSB index RSRP, an SSB index SINR, a CSI-RS resource indicator (CRI) RSRP, or a CRI SINR.

Aspect 67: The method of any of Aspects 64-66, wherein the secondary set of CSI measurements corresponds to a set of reference signals associated with the reference signal resource set, and wherein the set of reference signals is indicated by at least one of a wireless communication standard or the configuration.

Aspect 68: The method of any of Aspects 64-67, wherein a quantity of CSI reports of the at least one CSI report is indicated by at least one of a wireless communication standard or the configuration.

Aspect 69: The method of any of Aspects 64-68, wherein a quantization of the at least one CSI report is indicated by at least one of a wireless communication standard or the configuration.

Aspect 70: The method of any of Aspects 64-69, wherein the at least one CSI report consists of a single CSI report.

Aspect 71: The method of Aspect 70, further comprising receiving, from an additional network node, a capability report that indicates a maximum quantity of reported CSI measurements that the additional network node is capable of reporting in the single CSI report, the maximum quantity of reported CSI measurements comprising a sum of a maximum quantity of CSI measurements of the primary set of CSI measurements and a maximum quantity of CSI measurements of the secondary set of CSI measurements.

Aspect 72: The method of either of Aspects 70 or 71, further comprising receiving, from an additional network node, a capability report comprising an indication of a maximum quantity of reported CSI measurements that the additional network node is capable of reporting in the single CSI report, wherein the indication indicates a maximum quantity of CSI measurements of the secondary set of CSI measurements.

Aspect 73: The method of any of Aspects 70-72, wherein the one or more CSI report settings consists of a single CSI report setting corresponding to the single CSI report, the CSI report setting indicating the primary set of CSI measurements and the secondary set of CSI measurements.

Aspect 74: The method of Aspect 73, wherein the single CSI report setting comprises a configuration of the primary set of CSI measurements and a configuration of the secondary set of CSI measurements.

Aspect 75: The method of Aspect 73, wherein the single CSI report setting comprises: a configuration of the primary set of CSI measurements; and a configuration of a difference between a total set of CSI measurements and the primary set of CSI measurements, wherein the total set of CSI measurements comprises the primary set of CSI measurements and the secondary set of CSI measurements.

Aspect 76: The method of any of Aspects 70-75, wherein receiving the at least one CSI report comprises: receiving a first communication comprising a first part of the single CSI report; and receiving a second communication comprising a second part of the single CSI report.

Aspect 77: The method of Aspect 76, wherein the first part of the single CSI report includes the primary set of CSI measurements, and wherein the second part of the single CSI report includes the secondary set of CSI measurements.

Aspect 78: The method of any of Aspects 64-69, wherein the at least one CSI report comprises a plurality of CSI reports.

Aspect 79: The method of Aspect 78, wherein the one or more CSI report settings comprises a plurality of CSI report settings corresponding to the plurality of CSI reports.

Aspect 80: The method of Aspect 79, further comprising receiving, from an additional network node, a capability report that indicates a maximum quantity of reported CSI measurements that the additional network node is capable of reporting in the plurality of CSI reports, the maximum quantity of reported CSI measurements comprising a maximum quantity of CSI measurements of the secondary set of CSI measurements, wherein the plurality of CSI report settings are based at least in part on the capability report.

Aspect 81: The method of either of Aspects 79 or 80, wherein the plurality of CSI report settings include: a CSI report setting corresponding to the primary set of CSI measurements; and at least one additional CSI report setting corresponding to the secondary set of CSI measurements.

Aspect 82: The method of Aspect 81, wherein a first periodicity corresponding to a first time period between CSI report transmissions is associated with the CSI report setting, and a second periodicity corresponding to a second time period between CSI transmissions is associated with the at least one additional CSI report setting, wherein the second time period is longer than the first time period.

Aspect 83: The method of either of Aspects 81 or 82, wherein the at least one additional CSI report setting comprises a plurality of additional CSI report settings, wherein a total quantity of reference signals in a set of reference signals corresponding to the reference signal resource set, and associated with the plurality of additional CSI report settings, is no greater than a maximum quantity, indicated in a capability report, of CSI measurements of the secondary set of CSI measurements.

Aspect 84: The method of Aspect 83, wherein a first additional CSI report setting of the plurality of additional CSI report settings indicates a first subset of reference signals of the set of reference signals, and wherein a second additional CSI report setting of the plurality of additional CSI report settings indicates a second subset of reference signals of the set of reference signals, wherein the second subset of reference signals is different than the first subset of reference signals.

Aspect 85: The method of Aspect 84, wherein at least one of an association between the first subset of reference signals and the first additional CSI report setting or an association between the second subset of reference signals and the second additional CSI report setting is indicated by at least one of a wireless communication standard or the configuration.

Aspect 86: The method of any of Aspects 78-85, wherein at least one CSI processing unit (CPU) is associated with the plurality of CSI reports.

Aspect 87: The method of Aspect 86, wherein the at least one CPU consists of a single CPU corresponding to the plurality of CSI reports.

Aspect 88: The method of Aspect 87, the single CPU is associated with a CSI report of the plurality of CSI reports, wherein the CSI report corresponds to the primary set of CSI measurements.

Aspect 89: The method of any of Aspects 85-88, further comprising receiving a capability report that indicates a maximum quantity of CPUs associated with the plurality of CSI reports.

Aspect 90: The method of any of Aspects 64-89, wherein the secondary set of CSI measurements comprises at least one of a strongest RSRP value or a strongest SINR associated with a remaining set of CSI measurements, the remaining set of CSI measurements comprising each CSI measurement of the plurality of CSI measurements that is not included in the primary set of CSI measurements.

Aspect 91: The method of Aspect 90, wherein the one or more CSI report settings comprises: a first CSI report setting associated with the primary set of CSI measurements; and a second CSI report setting associated with the secondary set of CSI measurements, the first CSI report setting indicating an index corresponding to the second CSI report setting, and wherein the first CSI report setting indicates at least one rule associated with reporting the at least one of the strongest RSRP value or the strongest SINR associated with the remaining set of CSI measurements.

Aspect 92: The method of Aspect 90, wherein the one or more CSI report settings comprises: a first CSI report setting associated with the primary set of CSI measurements; and a second CSI report setting associated with the secondary set of CSI measurements, the second CSI report setting indicating an index corresponding to the first CSI report setting, and wherein the second CSI report setting indicates at least one rule associated with reporting the at least one of the strongest RSRP value or the strongest SINR associated with the remaining set of CSI measurements.

Aspect 93: The method of Aspect 90, wherein the one or more CSI report settings comprises a first CSI report setting and a second CSI report setting, and wherein the configuration indicates: an index corresponding to the first CSI report setting, an index corresponding to the second CSI report setting, and at least one rule associated with reporting the at least one of the strongest RSRP value or the strongest SINR associated with the remaining set of CSI measurements.

Aspect 94: The method of any of Aspects 90-93, wherein the one or more CSI report settings comprises: a CSI report setting associated with the primary set of CSI measurements; and at least one additional CSI report setting associated with the at least one of the strongest RSRP value or the strongest SINR associated with the remaining set of CSI measurements.

Aspect 95: The method of Aspect 94, wherein the at least one additional CSI report setting comprises: a first additional CSI report setting associated with a first subset of the at least one of the strongest RSRP value or the strongest SINR associated with the remaining set of CSI measurements, wherein the first subset of the at least one of the strongest RSRP value or the strongest SINR associated with the remaining set of CSI measurements comprises at least one of a strongest RSRP value or a strongest SINR associated with at least one of a strongest RSRP value or a strongest SINR associated with the remaining set of CSI measurements; and a second additional CSI report setting associated with a second subset of the at least one of the strongest RSRP value or the strongest SINR associated with the remaining set of CSI measurements, wherein the second subset of the at least one of the strongest RSRP value or the strongest SINR associated with the remaining set of CSI measurements comprises at least one of a strongest RSRP value or a strongest SINR associated with an additional remaining set of CSI measurements, the additional remaining set of CSI measurements comprising each CSI measurement of the at least one of the strongest RSRP value or the strongest SINR that is not included in the first subset of the at least one of the strongest RSRP value or the strongest SINR associated with the remaining set of CSI measurements.

Aspect 96: The method of Aspect 95, wherein the CSI report setting indicates: an index corresponding to the at least one additional CSI report setting, and at least one rule associated with reporting the at least one of the strongest RSRP value or the strongest SINR associated with the remaining set of CSI measurements.

Aspect 97: The method of Aspect 95, wherein the first additional CSI report setting indicates: an index corresponding to the CSI report setting, an index corresponding to the second additional CSI report setting, and at least one rule associated with reporting the at least one of the strongest RSRP value or the strongest SINR associated with the remaining set of CSI measurements.

Aspect 98: The method of Aspect 95, wherein the configuration indicates: a first index corresponding to the CSI report setting, a second index corresponding to the first additional CSI report setting, a third index corresponding to the second additional CSI report setting, and an order of the first index, the second index, and the third index based at least in part on a first CSI measurement strength level associated with the CSI report setting, a second CSI measurement strength level associated with the first additional CSI report setting, and a third CSI measurement strength level associated with the second additional CSI report setting.

Aspect 99: The method of Aspect 94, wherein a first priority associated with a first CSI report setting of the CSI report setting and the at least one additional CSI report setting is higher than a second priority associated with a second CSI report setting of the CSI report setting and the at least one additional CSI report setting based at least in part on at least one CSI measurement strength associated with the first CSI report being greater than at least one additional CSI measurement strength associated with the second CSI report.

Aspect 100: The method of Aspect 94, wherein a first priority associated with at least one CSI measurement of a single CSI report setting of the CSI report setting and the at least one additional CSI report setting is higher than a second priority associated with at least one additional CSI measurement of the single CSI report setting based at least in part on at least one measurement strength associated with the at least one CSI measurement being greater than at least one additional measurement strength associated with the at least one additional CSI measurement.

Aspect 101: The method of any of Aspects 64-100, wherein a CSI measurement of the secondary set of CSI measurements is adjacent to a CSI measurement of the primary set of CSI measurements.

Aspect 102: The method of Aspect 101, wherein a first reference signal identifier (ID) corresponds to the CSI measurement of the secondary set of CSI measurements and a second reference signal ID corresponds to the CSI measurement of the primary set of CSI measurements, and wherein the CSI measurement of the secondary set of CSI measurements is adjacent to the CSI measurement of the primary set of CSI measurements based at least in part on the first reference signal ID being adjacent to the second reference signal ID.

Aspect 103: The method of either of Aspects 101 or 102, wherein the CSI measurement of the secondary set of CSI measurements is adjacent to the CSI measurement of the primary set of CSI measurements based at least in part on a minimum angular separation between a beam corresponding to the CSI measurement of the primary set of CSI measurements and a beam corresponding to the CSI measurement of the secondary set of CSI measurements.

Aspect 104: The method of any of Aspects 64-103, wherein a quantity of CSI measurements of the primary set of CSI measurements is equal to a quantity of adjacent CSI measurements of the secondary set of CSI measurements.

Aspect 105: The method of any of Aspects 64-103, wherein a quantity of CSI measurements of the primary set of CSI measurements is not equal to a quantity of adjacent CSI measurements of the secondary set of CSI measurements.

Aspect 106: The method of Aspect 105, wherein a ratio of the quantity of adjacent CSI measurements of the secondary set of CSI measurements to the quantity of CSI measurements of the primary set of CSI measurements is indicated by at least one of a wireless communication standard or the configuration.

Aspect 107: The method of either of Aspects 105 or 106, wherein the primary set of CSI measurements comprises: a first subset of CSI measurements, wherein the first subset of CSI measurements comprises at least one of a strongest RSRP value or a strongest SINR associated with primary set of CSI measurements; and a second subset of CSI measurements, wherein the second subset of CSI measurements comprises at least one of a strongest RSRP value or a strongest SINR associated with a remaining subset of CSI measurements of the primary set of CSI measurements, the remaining subset of CSI measurements comprising each CSI measurement of the primary set of CSI measurements that is not included in the first subset of CSI measurements.

Aspect 108: The method of Aspect 107, wherein the configuration indicates: a first quantity of adjacent CSI measurements, of the secondary set of CSI measurements, associated with the first subset of CSI measurements; and a second quantity of adjacent CSI measurements, of the secondary set of CSI measurements, associated with the second subset of CSI measurements.

Aspect 109: The method of any of Aspects 64-108, wherein the secondary set of CSI measurements comprises at least one adjacent CSI measurement of a plurality of adjacent CSI measurements, wherein at least one reference signal identifier (ID) corresponding to the at least one adjacent CSI measurement satisfies a reference signal ID condition.

Aspect 110: The method of Aspect 109, wherein the at least one reference signal ID satisfies the reference signal ID condition based at least in part on the at least one reference signal ID having a value that is less than at least one additional value of at least one additional reference signal ID corresponding to at least one additional adjacent CSI measurement of the plurality of adjacent CSI measurements.

Aspect 111: The method of Aspect 109, wherein the at least one reference signal ID satisfies the reference signal ID condition based at least in part on the at least one reference signal ID having a value that is less than at least one additional value of at least one additional reference signal ID corresponding to at least one additional adjacent CSI measurement of the plurality of adjacent CSI measurements.

Aspect 112: The method of any of Aspects 109-111, wherein the at least one CSI report indicates a set of reference signal IDs corresponding to the primary set of CSI measurements, and wherein the at least one CSI report does not indicate a reference signal ID corresponding to the at least one adjacent CSI measurement.

Aspect 113: The method of Aspect 112, wherein the at least one adjacent CSI measurement comprises: a first adjacent CSI measurement, wherein a value of a first reference signal ID corresponding to the first adjacent CSI measurement is one greater than a value of a second reference signal ID corresponding to a CSI measurement of the primary set of CSI measurements; and a second adjacent CSI measurement, wherein a value of a third reference signal ID corresponding to the second adjacent CSI measurement is one less than a value of the second reference signal ID.

Aspect 114: The method of Aspect 112, wherein the at least one CSI report comprises: a first indication of an adjacent CSI measurement of the at least one CSI measurement, wherein a value of a first reference signal ID corresponding to the adjacent CSI measurement is one greater than a value of a second reference signal ID corresponding to a CSI measurement of the primary set of CSI measurements or one less than the value of a second reference signal ID corresponding to a CSI measurement of the primary set of CSI measurements; and a second indication of the adjacent CSI measurement.

Aspect 115: The method of Aspect 112, wherein the at least one CSI report comprises only one indication of an adjacent CSI measurement of the at least one CIS measurement, wherein a value of a first reference signal ID corresponding to the adjacent CSI measurement is one greater than a value of a second reference signal ID corresponding to a CSI measurement of the primary set of CSI measurements or one less than the value of a second reference signal ID corresponding to a CSI measurement of the primary set of CSI measurements.

Aspect 116: The method of Aspect 115, wherein the at least one CSI report comprises the only one indication of the adjacent CSI measurement based at least in part on a payload size associated with the at least one CSI report.

Aspect 117: The method of any of Aspects 64-116, wherein the at least one CSI report is quantized based at least in part on: a quantization method associated with the primary set of CSI measurements; and at least one additional quantization method associated with the secondary set of CSI measurements.

Aspect 118: The method of Aspect 117, wherein the at least one additional quantization method corresponds to a differential report of a CSI measurement of the secondary set of CSI measurements based at least in part on a relative CSI measurement strength associated with a CSI measurement of the primary set of CSI measurements.

Aspect 119: The method of Aspect 117, wherein the at least one additional quantization method corresponds to: a differential report of at least one CSI measurement of a first subset of the secondary set of CSI measurements relative to at least one CSI measurement of the primary set of CSI measurements; and a differential report of at least one CSI measurement of a second subset of the secondary set of CSI measurements relative to the at least one CSI measurement of the first subset.

Aspect 120: The method of Aspect 119, wherein the differential report of the at least one CSI measurement of the second subset comprises a differential report of the at least one CSI measurement of the second subset based at least in part on a relative CSI measurement strength associated with the at least one CSI measurement of the first subset.

Aspect 121: The method of Aspect 117, wherein the at least one additional quantization method associated with the secondary set of CSI measurements corresponds to a differential report of a CSI measurement of the secondary set of CSI measurements relative to an adjacent CSI measurement of the primary set of CSI measurements.

Aspect 122: The method of any of Aspects 64-121, wherein the at least one CSI report is quantized based at least in part on: a quantization method associated with the primary set of CSI measurements based at least in part on a quantization parameter value; and at least one additional quantization method associated with the secondary set of CSI measurements based at least in part on at least one additional quantization parameter value, wherein the at least one additional quantization parameter value is different than the quantization parameter value.

Aspect 123: The method of Aspect 122, wherein the quantization parameter value indicates at least one of a quantization step size or a dynamic range.

Aspect 124: An apparatus for wireless communication at a device, comprising a processor; memory coupled with the processor; and instructions stored in the memory and executable by the processor to cause the apparatus to perform the method of one or more of Aspects 1-63.

Aspect 125: A device for wireless communication, comprising a memory and one or more processors coupled to the memory, the one or more processors configured to perform the method of one or more of Aspects 1-63.

Aspect 126: An apparatus for wireless communication, comprising at least one means for performing the method of one or more of Aspects 1-63.

Aspect 127: A non-transitory computer-readable medium storing code for wireless communication, the code comprising instructions executable by a processor to perform the method of one or more of Aspects 1-63.

Aspect 128: A non-transitory computer-readable medium storing a set of instructions for wireless communication, the set of instructions comprising one or more instructions that, when executed by one or more processors of a device, cause the device to perform the method of one or more of Aspects 1-63.

Aspect 129: An apparatus for wireless communication at a device, comprising a processor; memory coupled with the processor; and instructions stored in the memory and executable by the processor to cause the apparatus to perform the method of one or more of Aspects 64-123.

Aspect 130: A device for wireless communication, comprising a memory and one or more processors coupled to the memory, the one or more processors configured to perform the method of one or more of Aspects 64-123.

Aspect 131: An apparatus for wireless communication, comprising at least one means for performing the method of one or more of Aspects 64-123.

Aspect 132: A non-transitory computer-readable medium storing code for wireless communication, the code comprising instructions executable by a processor to perform the method of one or more of Aspects 64-123.

Aspect 133: A non-transitory computer-readable medium storing a set of instructions for wireless communication, the set of instructions comprising one or more instructions that, when executed by one or more processors of a device, cause the device to perform the method of one or more of Aspects 64-123.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A network node for wireless communication, comprising:
a memory; and
one or more processors, coupled to the memory, configured to:
receive a configuration corresponding to one or more channel state information (CSI) report settings associated with a reference signal resource set; and
transmit, based at least in part on the configuration, at least one CSI report that indicates a primary set of CSI measurements, of a plurality of CSI measurements associated with the reference signal resource set, and a secondary set of CSI measurements of the plurality of CSI measurements, wherein the plurality of CSI measurements comprises at least one of a physical layer reference signal received power (RSRP) value or a physical layer signal-to-interference-plus-noise ratio (SINR), and wherein the primary set of CSI measurements comprises at least one of a strongest RSRP value or a strongest SINR associated with the plurality of CSI measurements and the secondary set of CSI measurements comprises one or more CSI measurements that are not included in the primary set of CSI measurements.

2. The network node of claim 1, wherein the reference signal resource set comprises at least one of:
a CSI reference signal (CSI-RS) set, or
a synchronization signal block (SSB) resource set.

3. The network node of claim 2, wherein the plurality of CSI measurements comprises at least one of:
an SSB index RSRP,
an SSB index SINR,
a CSI-RS resource indicator (CRI) RSRP, or
a CRI SINR.

4. The network node of claim 1, wherein the at least one CSI report consists of a single CSI report.

5. The network node of claim 4, wherein the one or more CSI report settings consists of a single CSI report setting corresponding to the single CSI report, the CSI report setting indicating the primary set of CSI measurements and the secondary set of CSI measurements.

6. The network node of claim 4, wherein the one or more processors, to transmit the at least one CSI report, are configured to:
transmit a first communication comprising a first part of the single CSI report, wherein the first part of the single CSI report includes the primary set of CSI measurements; and
transmit a second communication comprising a second part of the single CSI report, wherein the second part of the single CSI report includes the secondary set of CSI measurements.

7. The network node of claim 1, wherein the at least one CSI report comprises a plurality of CSI reports.

8. The network node of claim 7, wherein the one or more CSI report settings comprises a plurality of CSI report settings corresponding to the plurality of CSI reports.

9. The network node of claim 8, wherein the plurality of CSI report settings include:
a CSI report setting corresponding to the primary set of CSI measurements; and
at least one additional CSI report setting corresponding to the secondary set of CSI measurements.

10. The network node of claim 9, wherein a first periodicity corresponding to a first time period between CSI report transmissions is associated with the CSI report setting, and a second periodicity corresponding to a second time period between CSI transmissions is associated with the at least one additional CSI report setting, wherein the second time period is longer than the first time period.

11. The network node of claim 9, wherein the at least one additional CSI report setting comprises a plurality of additional CSI report settings, wherein a total quantity of reference signals in a set of reference signals corresponding to the reference signal resource set, and associated with the plurality of additional CSI report settings, is no greater than a maximum quantity, indicated in a capability report, of CSI measurements of the secondary set of CSI measurements.

12. The network node of claim 11, wherein a first additional CSI report setting of the plurality of additional CSI report settings indicates a first subset of reference signals of the set of reference signals, and wherein a second additional CSI report setting of the plurality of additional CSI report settings indicates a second subset of reference signals of the set of reference signals, wherein the second subset of reference signals is different than the first subset of reference signals.

13. The network node of claim 7, wherein the one or more processors are further configured to determine at least one CSI processing unit (CPU) associated with the plurality of CSI reports.

14. The network node of claim 13, wherein the at least one CPU consists of a single CPU corresponding to the plurality of CSI reports.

15. The network node of claim 14, wherein the one or more processors are further configured to associate the single CPU with a CSI report of the plurality of CSI reports, wherein the CSI report corresponds to the primary set of CSI measurements.

16. The network node of claim 1, wherein the secondary set of CSI measurements comprises at least one of a strongest RSRP value or a strongest SINR associated with a remaining set of CSI measurements, the remaining set of CSI measurements comprising each CSI measurement of the plurality of CSI measurements that is not included in the primary set of CSI measurements.

17. The network node of claim 16, wherein the one or more CSI report settings comprises:
a first CSI report setting associated with the primary set of CSI measurements; and
a second CSI report setting associated with the secondary set of CSI measurements, at least one of the first CSI report setting, the second CSI report setting, or a third CSI report setting indicating an index corresponding to the second CSI report setting, and wherein the at least one of the first CSI report setting, the second CSI report setting, or the third CSI report setting indicates at least one rule associated with reporting the at least one of the strongest RSRP value or the strongest SINR associated with the remaining set of CSI measurements.

18. The network node of claim 16, wherein the one or more CSI report settings comprises:
a CSI report setting associated with the primary set of CSI measurements; and
at least one additional CSI report setting associated with the at least one of the strongest RSRP value or the strongest SINR associated with the remaining set of CSI measurements.

19. The network node of claim 1, wherein a CSI measurement of the secondary set of CSI measurements is adjacent to a CSI measurement of the primary set of CSI measurements.

20. The network node of claim 1, wherein the one or more processors are further configured to:
identify a plurality of adjacent CSI measurements of the plurality of CSI measurements;
determine that a quantity of adjacent CSI measurements of the plurality of adjacent CSI measurements satisfies a measurement quantity threshold; and
determine, based at least in part on determining that the quantity of adjacent CSI measurements satisfies the measurement threshold, that at least one reference signal identifier (ID) corresponding to at least one adjacent CSI measurement, of the plurality of adjacent CSI measurements, satisfies a reference signal ID condition, wherein the secondary set of CSI measurements comprises the at least one adjacent CSI measurement based at least in part on determining that the at least one reference signal ID satisfies the reference signal ID condition.

21. The network node of claim 1, wherein the one or more processors, to transmit the at least one CSI report, are configured to:
perform a quantization method associated with the primary set of CSI measurements; and
perform at least one additional quantization method associated with the secondary set of CSI measurements.

22. The network node of claim 21, wherein the one or more processors, to perform the at least one additional quantization method, are configured to differentially report a CSI measurement of the secondary set of CSI measurements based at least in part on a relative CSI measurement strength associated with a CSI measurement of the primary set of CSI measurements.

23. The network node of claim 21, wherein the one or more processors, to perform the at least one additional quantization method, are configured to:
differentially report at least one CSI measurement of a first subset of the secondary set of CSI measurements relative to at least one CSI measurement of the primary set of CSI measurements; and
differentially report at least one CSI measurement of a second subset of the secondary set of CSI measurements relative to the at least one CSI measurement of the first subset.

24. The network node of claim 1, wherein the one or more processors, to transmit the at least one CSI report, are configured to:
perform a quantization method associated with the primary set of CSI measurements based at least in part on a quantization parameter value; and
perform at least one additional quantization method associated with the secondary set of CSI measurements based at least in part on at least one additional quantization parameter value, wherein the at least one additional quantization parameter value is different than the quantization parameter value.

25. A network node for wireless communication, comprising:
a memory; and
one or more processors, coupled to the memory, configured to:
transmit a configuration corresponding to one or more channel state information (CSI) report settings associated with a reference signal resource set; and
receive, based at least in part on the configuration, at least one CSI report that indicates a primary set of CSI measurements, of a plurality of CSI measurements associated with the reference signal resource set, and a secondary set of CSI measurements of the plurality of CSI measurements, wherein the plurality of CSI measurements comprises at least one of a physical layer reference signal received power (RSRP) value or a physical layer signal-to-interference-plus-noise ratio (SINR), and wherein the primary set of CSI measurements comprises at least one of a strongest RSRP value or a strongest SINR associated with the plurality of CSI measurements and the secondary set of CSI measurements comprises one or more CSI measurements that are not included in the primary set of CSI measurements.

26. The network node of claim 25, wherein the reference signal resource set comprises at least one of a CSI reference signal (CSI-RS) set, or a synchronization signal block (SSB) resource set, and wherein the plurality of CSI measurements comprises at least one of:
an SSB index RSRP,
an SSB index SINR,
a CSI-RS resource indicator (CRI) RSRP, or
a CRI SINR.

27. A method of wireless communication performed by a network node, comprising:
receiving a configuration corresponding to one or more channel state information (CSI) report settings associated with a reference signal resource set; and
transmitting, based at least in part on the configuration, at least one CSI report that indicates a primary set of CSI measurements, of a plurality of CSI measurements associated with the reference signal resource set, and a secondary set of CSI measurements of the plurality of CSI measurements, wherein the plurality of CSI measurements comprises at least one of a physical layer reference signal received power (RSRP) value or a physical layer signal-to-interference-plus-noise ratio (SINR), and wherein the primary set of CSI measurements comprises at least one of a strongest RSRP value or a strongest SINR associated with the plurality of CSI measurements and the secondary set of CSI measurements comprises one or more CSI measurements that are not included in the primary set of CSI measurements.

28. The network node of claim 27, wherein the reference signal resource set comprises at least one of a CSI reference signal (CSI-RS) set, or a synchronization signal block (SSB) resource set, and wherein the plurality of CSI measurements comprises at least one of:
an SSB index RSRP,
an SSB index SINR,
a CSI-RS resource indicator (CRI) RSRP, or
a CRI SINR.

29. A method of wireless communication performed by a network node, comprising:
transmitting a configuration corresponding to one or more channel state information (CSI) report settings associated with a reference signal resource set; and
receiving, based at least in part on the configuration, at least one CSI report that indicates a primary set of CSI measurements, of a plurality of CSI measurements associated with the reference signal resource set, and a secondary set of CSI measurements of the plurality of CSI measurements, wherein the plurality of CSI measurements comprises at least one of a physical layer reference signal received power (RSRP) value or a physical layer signal-to-interference-plus-noise ratio (SINR), and wherein the primary set of CSI measurements comprises at least one of a strongest RSRP value or a strongest SINR associated with the plurality of CSI measurements and the secondary set of CSI measurements comprises one or more CSI measurements that are not included in the primary set of CSI measurements.

30. The method of claim 29, wherein the reference signal resource set comprises at least one of a CSI reference signal (CSI-RS) set, or a synchronization signal block (SSB) resource set, and wherein the plurality of CSI measurements comprises at least one of:
an SSB index RSRP,
an SSB index SINR,
a CSI-RS resource indicator (CRI) RSRP, or
a CRI SINR.
